(19) United States
(12) Patent Application Publication
(10) Pub. No.: US 2026/0244993 A1
(43) Pub. Date: Aug. 20, 2026

(54) SYSTEMS AND METHODS FOR PROVIDING AN ADAPTIVE MULTIMODAL AI ORCHESTRATION FRAMEWORK

(71) Applicant: Complet3D, Inc, Lexington, KY (US)

(72) Inventor: Joe Brewer, Lexington, KY (US)

(21) Appl. No.: 19/542,182

(22) Filed: Feb. 17, 2026

Related U.S. Application Data
(60) Provisional application No. 63/758,644, filed on Feb. 14, 2025.

(51) Int. Cl. G06N 20/00

(52) U.S. Cl. CPC G06N 20/00

(57) ABSTRACT

Systems and methods are provided that provide deterministic and explainable multimodal ingestion and policy-validated orchestration of artificial intelligence workflows. Input items of different modalities are canonicalized and transformed into a modality signature using deterministic feature transforms. A deterministic hierarchical tagging function assigns modality, sub-modality, descriptors, and sensitivity, and generates an ingestion-time explainability record including rule traces, evidence values, ambiguity measures, deterministic tie-break outcomes, and version identifiers. Ingestion metadata is provided to an orchestrator controller that compiles a typed structured execution plan specifying model selection, deployment location, privacy parameters, and explainability configuration. A policy-checking module evaluates machine-executable constraints and deterministically repairs noncompliant plan parameters while recording an audit trail. Execution proceeds according to the validated plan to produce inference and explanation outputs in edge and cloud environments.

### CROSS REFERENCE TO RELATED APPLICATIONS

This application claims the benefit of U.S. Provisional Patent Application No. 63/758,644, filed Feb. 14, 2025, entitled “SYSTEMS AND METHODS FOR PROVIDING AN ADAPTIVE MULTIMODAL AI ORCHESTRATION FRAMEWORK,” the contents of which are incorporated herein by reference in its entirety.

### TECHNICAL FIELD

Embodiments described herein relate to machine learning systems and, more particularly, to deterministic and explainable multimodal ingestion, tagging, policy-validated orchestration planning, and execution of predictive and generative models under resource, privacy, compliance, and deployment constraints in edge and cloud environments, including, in some embodiments, adversarially robust signature extraction, temporal concept drift detection, rule consistency verification, and deterministic cluster leadership selection under compute and privacy-budget constraints.

### BACKGROUND

Computing systems increasingly ingest heterogeneous inputs, including text streams, images, audio, video, and time-series sensor data. Many existing pipelines treat multimodal ingestion as an ad hoc preprocessing step and rely on dynamic workflow managers or agent-like systems for routing and tool selection. Such approaches commonly introduce one or more problems, such as non-deterministic preprocessing and routing decisions that are difficult to reproduce and audit; ingestion and classification pipelines that invoke expensive embedding generation, cross-modal fusion, or large-model inference even when a low-cost signal would suffice; post-hoc explainability that does not account for ingestion-time decisions (e.g., modality identification, sensitivity labeling, and descriptor assignment) that govern downstream routing; and policy and compliance checks implemented outside of a compiled execution plan, resulting in inconsistent enforcement and weak provenance.

These issues may be amplified in edge deployments and high-throughput environments, where compute budgets are constrained and latency is critical. For example, a system that performs large-model inference during ingestion merely to determine modality or sensitivity may exhibit excessive compute complexity. Conversely, a system that reduces compute cost by using opaque heuristics may fail to provide a defensible explanation of why a record was tagged as sensitive or why a request was routed to a particular execution environment.

In addition, multimodal ingestion and routing pipelines may be vulnerable to adversarial or incidental perturbations that alter ingestion-time tags or sensitivity labels, and may exhibit temporal drift in sensor and stream distributions that causes previously valid signatures, rules, or descriptor prototypes to degrade over time. Further, rule sets and policy constraints may contain latent contradictions that are not detected until runtime, and distributed edge clusters may require deterministic leadership selection and version migration protocols to ensure reproducible processing during dynamic cluster formation and policy updates.

Accordingly, there is a need for systems and methods that provide deterministic and explainable multimodal ingestion with bounded compute cost, and that integrate ingestion decisions into a typed and auditable orchestration plan that can be validated, repaired, and enforced under privacy, security, and compliance constraints prior to execution.

### SUMMARY

In some embodiments, the deterministic multimodal ingestion engine receives heterogeneous input items, converts each input item into a canonical representation, computes a fixed-length modality signature using a predetermined set of deterministic feature transforms, and applies a deterministic hierarchical tagging function to assign a modality identifier, a sub-modality identifier, at least one descriptor identifier, and a sensitivity level from an ordered set of sensitivity levels. In these embodiments, the ingestion engine generates an ingestion-time explainability record that includes rule traces, feature evidence values, ambiguity scores, confidence values, and version identifiers for rule sets, a compliant value (one or more) thresholds, feature transform specifications, models, and descriptor dictionaries.

In some embodiments, ingestion outputs are provided to an orchestrator controller that generates and compiles a typed structured execution plan specifying at least one predictive or generative model to execute, a deployment location (e.g., edge deployment, cloud deployment, or an ephemeral edge cluster deployment), privacy parameters (e.g., a differential privacy budget, differential privacy epsilon value, or noise scale), and an explainability configuration. A policy-checking module validates the plan by evaluating compiled constraints derived from a policy repository and, in some embodiments, a neural policy abstraction layer. If the plan violates a constraint, the policy-checking module deterministically repairs the plan, logs the violation and repair, and outputs a validated plan for execution.

In some embodiments, compute complexity is bounded through a multi-tier ingestion workflow that performs low-cost signature extraction and rule-based tagging by default, escalates to a lightweight learned classifier when ambiguity exceeds a threshold, and caches intermediate results using modality signatures to avoid redundant computation. A complexity governor may be utilized to enforce per-batch compute budgets by deterministically selecting between ingestion modes and by invoking deterministic fallbacks, while maintaining reproducibility using deterministic tie-breaking and versioned system state.

In some embodiments, an explainability aggregator merges local feature-attribution outputs at sub-second intervals into a unified time-slice attribution matrix spanning multiple modalities, and may optionally provide causal linking artifacts between modalities. In some embodiments, a federated and edge-cloud manager forms ephemeral edge clusters based on a deterministic threshold (at least one) and applies privacy parameter selection and enforcement as deterministic functions of sensitivity levels and remaining privacy budgets.

One embodiment of a system includes an ingestion engine configured to canonicalize heterogeneous input items, compute deterministic modality signatures, assign modality/submodality/descriptor/sensitivity tags using a deterministic hierarchical tagging function, and generate an ingestion-time explainability record including rule traces, evidence, and version identifiers; an orchestrator controller configured to generate and compile a typed structured execution plan; a policy-checking module configured to compile and evaluate machine-executable constraints over structured execution plan fields and to deterministically repair a noncompliant parameter (one or more); an execution subsystem configured to execute validated plans on edge, cloud, or ephemeral clusters; and an audit log configured to store ingestion-time and model-time evidence artifacts enabling reproducibility and compliance verification.

In some embodiments, the system provides certified adversarially robust signature extraction using randomized smoothing with formal robustness certificates stored in ingestion metadata, information-theoretic bounds for signature dimensionality selection using mutual information ranking and rate-distortion optimization; temporal concept drift detection using distribution divergence metrics to trigger deterministic cluster reformation and descriptor dictionary evolution, pre-deployment rule consistency verification using Boolean satisfiability checking with minimal conflict set identification; capacity-aware and privacy-budget-aware leader election for ephemeral edge clusters; and rule version migration protocols using version fences to ensure deterministic processing of in-flight items during rule upgrades.

In some embodiments, the deterministic repair of the structured execution plan occurs prior to execution of any predictive or generative model, such that at least one machine-executable policy constraint are satisfied before computational resources are committed. The orchestration framework is replayable in that, given identical system state and identical input items, the ingestion engine, the orchestrator controller, and the policy-checking module produce identical outputs, thereby preventing non-deterministic policy enforcement. Version identifiers associated with rule sets, feature transforms, descriptor dictionaries, and policy repositories ensure deterministic behavior under identical system state across successive invocations. Because repair is applied before model execution, every inference output is produced under a fully validated and auditable execution plan.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a high-level architecture for providing an adaptive multimodal AI orchestration framework, according to embodiments provided herein;

FIG. 2 depicts a multi-tier data ingestion pipeline for providing an adaptive multimodal AI orchestration framework, according to embodiments provided herein, according to embodiments provided herein;

FIG. 3 depicts a sequence for real-time, distributed feature-attribution generation at edge nodes and aggregation into a unified explanation output, according to embodiments provided herein;

FIG. 4 depicts federated model partitioning and dynamic privacy injection in connection with formation of an ephemeral edge-cloud cluster, according to embodiments provided herein;

FIG. 5 depicts a robustness certificate flow for deterministic modality signatures, according to embodiments provided herein;

FIG. 6 depicts adaptive signature dimensionality selection using information-theoretic criteria, according to embodiments provided herein;

FIG. 7 depicts concept drift detection and descriptor dictionary evolution, according to embodiments provided herein;

FIG. 8 depicts rule consistency verification using satisfiability checking and minimal conflict sets, according to embodiments provided herein;

FIG. 9 depicts capacity-aware leader election and privacy-budget-aware cluster control, according to embodiments provided herein;

FIG. 10 depicts a rule version migration protocol with version fences for in-flight processing, according to embodiments provided herein;

FIG. 11 depicts a flowchart for providing an adaptive multimodal artificial intelligence (AI) orchestration framework, according to embodiments provided herein; and

FIG. 12 depicts an example computing device that may implement one or more modules of the framework, according to embodiments provided herein.

### DETAILED DESCRIPTION

Embodiments disclosed herein include systems and methods for providing an adaptive multimodal AI orchestration framework. Some embodiments include a deterministic and explainable multimodal artificial intelligence (AI) orchestration framework. These embodiments of a multimodal ingestion engine may be configured to canonicalize heterogeneous input items and compute a modality signature using a predetermined, deterministic feature transform set selected to avoid expensive multimodal fusion during ingestion. A deterministic hierarchical tagging function may be utilized to assign a modality identifier, a sub-modality identifier, one or more descriptor identifiers, and a sensitivity level from an ordered set of sensitivity levels. The deterministic hierarchical tagging function may further generate an ingestion-time explainability record including rule traces, feature evidence, ambiguity indicators, and version identifiers. An orchestrator controller may also be included that compiles a typed structured execution plan specifying model selection, routing, deployment location, privacy parameters, and explainability configuration. A policy-checking module may be included that validates the plan using compiled constraints derived from a policy repository and, in some embodiments, a neural policy abstraction layer, and deterministically repairs at least one plan parameter, such as noncompliant plan parameters prior to execution while recording an audit trail. The framework bounds compute cost via early-exit gating, caching keyed by modality signatures, and a complexity governor that enforces per-batch compute budgets while maintaining reproducibility and auditability. The systems and methods for providing an adaptive multimodal AI orchestration framework incorporating the same will be described in more detail, below.

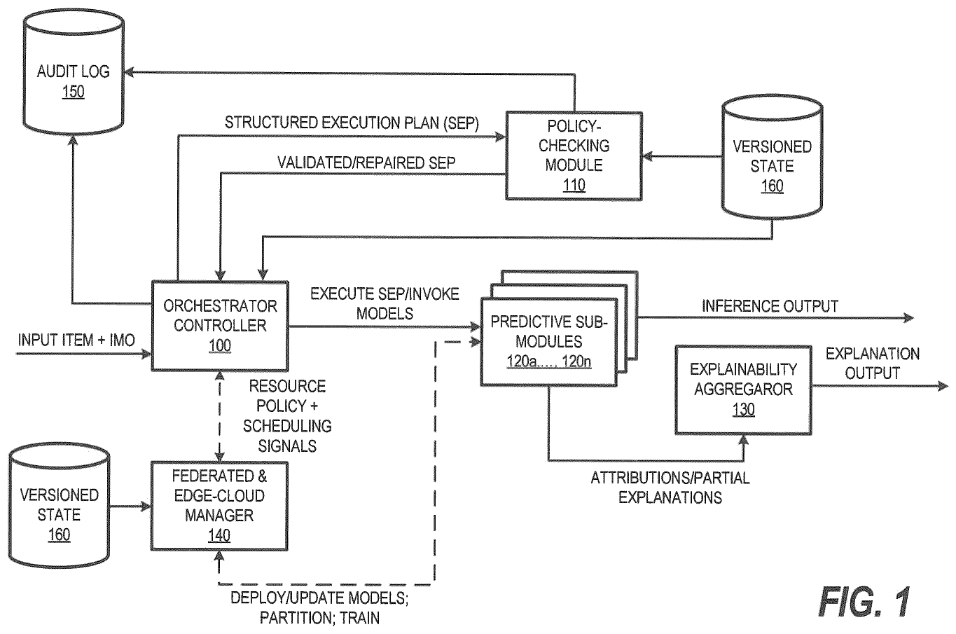

Referring now to the drawings, FIG. 1 depicts a high-level architecture for providing an adaptive multimodal AI orchestration framework, according to embodiments provided herein. As illustrated, the architecture may include an orchestrator controller 100, a policy-checking module 110, predictive sub-modules 120a, . . . , 120n, an explainability aggregator 130, a federated and edge-cloud manager 140, an audit log 150, and a version state log 160. The orchestrator controller 100 may receive input items enriched with ingestion metadata and generates and/or compiles a structured execution plan (SEP) that specifies which operations to execute, where to execute them, and under which privacy, security, and performance constraints.

In some embodiments, the policy-checking module 110 receives, validates and, if needed, revises the SEP according to applicable policy constraints. Predictive sub-modules 120a, . . . , 120n execute predictive and/or generative operations, such as including cross-modal fusion. The explainability aggregator 130 may receive and execute the SEP, as well as invoke models and produces explanation outputs, including time-slice feature-attribution outputs and narrative summaries. The federated and edge-cloud manager 140 receives attributions and/or partial explanations and coordinates distributed execution and may form ephemeral edge clusters to satisfy throughput and latency requirements. In some embodiments, the federated and edge-cloud manager may distribute at least one of following: training or inference tasks to edge devices, to form an ephemeral edge cluster based on a deterministic threshold for at least one of the following: observed load, latency, or modality composition, and to deterministically select a leader node for the ephemeral edge cluster based on at least one of the following: compute capacity or remaining privacy budget, with deterministic tie-breaking when two or more candidate nodes have equivalent capacity and budget.

In some embodiments, the policy-checking module 110 may house a neural policy abstraction (NPA) layer that translates textual policies (e.g., HIPAA statutes, GDPR paragraphs) into semantic embeddings. Policy texts, embeddings, and compliance thresholds are updated as versioned state updates (state_v); at runtime, enforcement behavior is deterministic given the same state_v, and any learning that produces updated thresholds or embeddings occurs offline and results in a new version identifier recorded in the audit log 150, which may also include a violation identifier and a repair reason code. In some embodiments, the policy-checking module 110 may be configured to validate or override candidate plan parameters in accordance with compiled constraints. If, for instance, a candidate plan specifies an ε-value that is noncompliant for an S5-labeled industrial log, the deterministic constraint evaluator deterministically repairs the parameter, ensuring compliance. The policy-checking module 110 and the orchestrator controller 100 may send data to the audit log 150. The policy-checking module 110 may also receive version states from the version state log 160.

The predictive sub-modules 120a, . . . , 120n may include diverse architectures, such as Bayesian networks for uncertainty analysis, Transformers for unstructured text, CNN-based models for imaging, etc. The predictive sub-modules 120a, . . . 120n may be configured to operate in parallel or sequential workflows depending on the compiled structured execution plan. The predictive sub-modules 120a, . . . , 120n may be further configured to output partial feature-attributions (e.g., SHAP values) in streaming mode, enabling near real-time interpretability.

The explainability aggregator 130 may merge partial attributions from sub-modules in sub-second intervals to produce a single, time-sliced view of feature importance across multiple data modalities. The explainability aggregator 130 may further invoke the LLM for generative explanation summaries (e.g., “rotor friction is the key contributor, likely due to last night's wind gusts”). The explainability aggregator 130 may be further configured to facilitate advanced causal attention linking for more interpretable cross-modal interactions. In some embodiments, the narrative summary is non-authoritative and the underlying attribution matrix is stored as the verifiable explanation artifact.

The federated learning and edge-cloud (FLEC) manager 140 may be configured to receive versioned states from the version state log 160 and direct training or inference tasks to geo-specific edge devices, referencing local constraints (e.g., bandwidth, hardware specs). The FLEC manager 140 may dynamically inject or remove differential privacy noise in response to sensitivity triggers, as validated by the policy-checking module 110. The FLEC manager 140 further forms ephemeral edge clouds by deterministic online bucketing and/or deterministic online clustering procedure multiple local nodes to handle surges in data volume or complexity, dissolving them after processing. The FLEC manager 140 may be configured to maintain a repository of regionalized sub-models, applying neural partitioning (splitting or merging model layers) to suit each edge device's capabilities.

Some embodiments may maintain an audit log 150 comprising at least one of the following: IMOs, SEPs, constraint evaluations, repair actions, execution outcomes, or explanation artifacts. The audit log 150 may be stored in an append-only ledger or other tamper-evident storage to support compliance and debugging.

Deterministic Multimodal Ingestion with Bounded Compute Cost

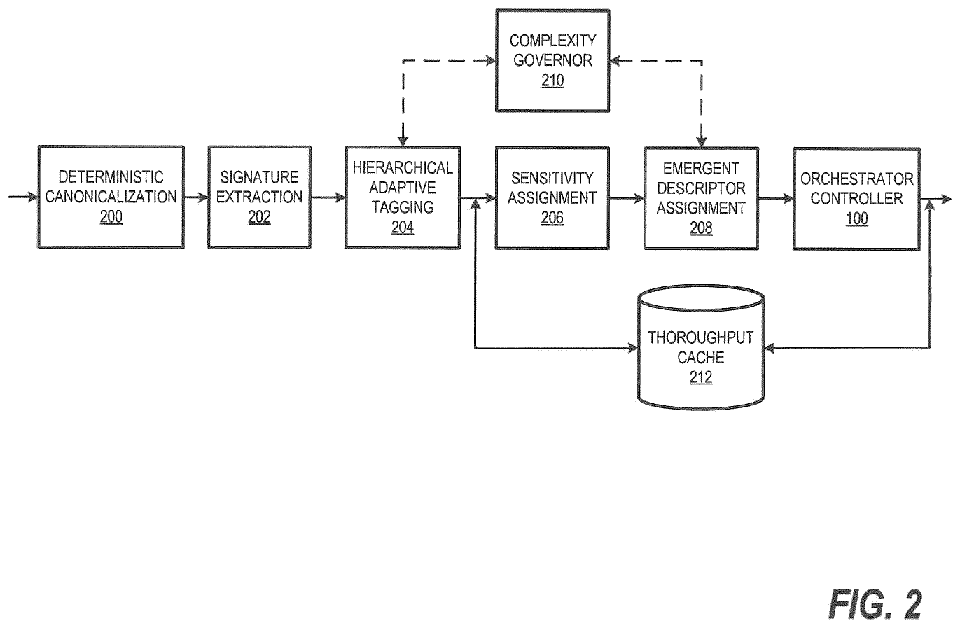

FIG. 2 depicts a multi-tier data ingestion pipeline for providing an adaptive multimodal AI orchestration framework, according to embodiments provided herein, according to embodiments provided herein. As illustrated, the multi-tier data ingestion pipeline includes a deterministic canonicalization module 200, a signature extraction module 202, a hierarchical adaptive tagging module 204, a sensitivity assignment module 206, an emergent descriptor assignment module 208, a complexity governor module 210, a throughput cache 212, and the orchestrator controller 100 (FIG. 1). The ingestion pipeline may be configured to (i) deterministically identify modality and sub-modality, (ii) deterministically assign sensitivity levels, (iii) deterministically assign descriptor identifiers for known or emergent data types, (iv) generate ingestion-time explainability records, and/or (v) bound compute cost using early-exit gating, caching, and complexity governance.

Also provided in FIG. 2 are self-learning meta-descriptors. The self-learning meta-descriptors may be configured as local neural network updates to cluster new or unexpected data types (e.g., “drone-LIDAR waveforms,” “encrypted partial sensor dump”). Each cluster may be annotated with emergent descriptors (e.g., “night-vision feed,” “HIPAA-covered record”) that inform the orchestrator controller 100.

Similarly, some embodiments include the throughput cache 212. In high-throughput environments, some embodiments pre-allocate computing resources based on predicted data bursts (e.g., from satellite or drone feeds). The throughput cache 212 may reduce latency by around 30% in certain deployments, ensuring more consistent flow to the orchestrator controller 100. As data enters the orchestrator controller 100, it is already enriched with high-fidelity context (e.g., “image: retina scan, S4, emergent descriptor: IR-sensitive”). The orchestrator controller 100 can thus make informed routing and privacy decisions.

### A. Canonicalization

In the deterministic canonicalization module 200, each input item x is converted to a canonical representation c(x) prior to feature extraction. Canonicalization may include, without limitation:
Text: normalize encoding (e.g., UTF-8), normalize line endings, normalize whitespace, normalize Unicode forms, remove non-semantic metadata fields, and deterministically order structured fields (e.g., JSON keys).
Images/video frames: normalize orientation, normalize color space, deterministically down sample to a bounded thumbnail for signature extraction (e.g., 64×64 or 128×128), and remove non-semantic metadata fields used only for transport.
Audio: normalize an sampling rate to a canonical rate (or compute deterministic band features), normalize amplitude to a canonical range, and segment into deterministic windows.
Sensor streams: segment into deterministic time windows, resample to a canonical audio sampling rate (or compute deterministic summary statistics), normalize units when a unit mapping is available, and deterministically align channel ordering.

Canonicalization reduces incidental variation and enables stable feature extraction, stable cache keys, and stable downstream tags.

### B. Modality Signature Extraction

In some embodiments, the signature extraction module 202 computes a modality signature s(x) from the canonical representation c(x) using a predetermined set of deterministic feature transforms. The modality signature is configured to be inexpensive to compute relative to full embedding generation, foundation-model inference, or cross-modal fusion.

Text signature example (non-limiting): character n-gram counts, token length distribution, language identifier, deterministic keyword sketches, and deterministic feature hashing into a fixed-length vector.

Image signature example (non-limiting): resolution and aspect ratio, deterministic histograms (e.g., gradient magnitude histogram with fixed bins), and a low-rank sketch computed from a down sampled thumbnail.

Audio signature example (non-limiting): deterministic mel-band energies, spectral centroid, and zero-crossing rate computed over deterministic windows.

Sensor signature example (non-limiting): windowed mean, variance, kurtosis, deterministic FFT band energies using a fixed FFT size (e.g., 256 or 512), and deterministic quantization into a fixed-length sketch.

In some embodiments, s(x) is a vector in R\hat{ }d where d is selected to bound compute and memory (e.g., d=32, 64, 128, or 256). In some embodiments, s(x) is a fixed-length bitstring produced by a deterministic locality-sensitive hash.

In some embodiments, the ingestion pipeline computes a stable cache key h(x) as a hash of c(x), s(x), and/or selected metadata (e.g., schema version). The cache key is used for throughput caching and deterministic deduplication of repeated input items.

### C. Deterministic Hierarchical Adaptive Tagging (HAT)

In some embodiments, the hierarchical adaptive tagging module 204 assigns a tag record t(x) comprising (i) modality identifier m, (ii) sub-modality identifier sm, (iii) sensitivity level sL, and (iv) descriptor identifiers. Tagging is performed using a deterministic tagging function T that maps signature and metadata to tags. A non-limiting example is: t(x)=T(s(x), meta(x), state_v), where state_v represents versioned system state including feature transform specifications, rule sets, thresholds, classifier versions, and descriptor dictionaries.

In some embodiments, the hierarchical adaptive tagging module 204 includes a versioned rule engine evaluates a set of rules R={r1 . . . rN}. Each rule tests conditions on s(x) and meta(x) and emits one or more candidate modality/sub-modality labels and confidence values. Rule evaluation order is deterministic, and an ordered rule trace is recorded in the IER.

In some embodiments, the hierarchical adaptive tagging module 204 includes an ingestion engine that computes an ambiguity score “A” from rule outputs. “A” may be computed as an entropy over candidate labels, a margin between the top two candidate confidences, or another deterministic measure. If “A” is below a threshold, the ingestion engine assigns tags without invoking a learned classifier. This provides a deterministic early exit that reduces compute cost.

In some embodiments, when ambiguity exceeds a threshold, the ingestion engine invokes a lightweight classifier C operating on s(x) rather than raw data. C may be a shallow neural network, logistic regression, gradient-boosted tree, or another model selected for low inference cost. Determinism is enforced by fixed model parameters, deterministic preprocessing, deterministic operators, and deterministic tie-breaking for equal or near-equal scores.

In some embodiments, when multiple candidates remain after rule evaluation or classification, the ingestion engine applies a deterministic tie-breaking function, such as selecting the candidate with the lowest stable identifier, selecting based on a stable sort of identifiers, or selecting based on a versioned preference list. The tie-break decision is recorded in the IER.

### D. Sensitivity Assignment

In some embodiments, the sensitivity assignment module 206 assigns sensitivity via a deterministic risk score r(x) mapped into discrete sensitivity levels (e.g., S1 . . . . S5). Sensitivity levels may represent escalating categories, such as public, internal, confidential, restricted, and critical, though the labels are not limiting. As an example, some embodiments may compute a deterministic risk score as a weighted combination of at least two of the following: a personally identifiable information indicator, a domain indicator, a residency indicator, a novelty indicator, and an encryption-state indicator, and mapping the deterministic risk score to the plurality of ordered sensitivity levels using a deterministic threshold

A non-limiting example risk score is:

$$r ( x ) = w 1 \cdot PII ( c ( x ) ) + w 2 \cdot Domain ( c ( x ) ) + w 3 \cdot ResidencyRisk ( meta ( x ) ) + w 4 \cdot Novelty ( s ( x ) ) + w 5 \cdot EncryptionState ( meta ( x ) )$$

PII(c(x)) may be computed using deterministic detectors such as pattern matching, dictionaries, or fixed classifiers; Domain(c(x)) may be computed using deterministic domain rules or fixed classifiers; ResidencyRisk(meta(x)) may be derived from jurisdiction metadata; Novelty(s(x)) may be based on distance to known descriptor prototypes; and EncryptionState(meta(x)) may reflect whether data is encrypted or originates from a trusted enclave. The weights and thresholds are versioned. Sensitivity level sL is assigned by thresholding r(x) into discrete bins using at least one deterministic threshold.

In some embodiments, the sensitivity assignment further yields a sensitivity rationale object included in the IER, comprising which detectors fired, which patterns matched, and which thresholds were crossed.

### E. Emergent Descriptor Assignment with Deterministic Updates

Some embodiments of the emergent descriptor assignment module 208 assigns at least one descriptor identifier that represent known or emergent data types. Descriptor assignment may be based on a descriptor embedding e(x) computed as a deterministic projection of s(x), which may be a low-dimensional projection. In some embodiments, e(x) is computed using feature hashing or a fixed random projection matrix stored in versioned state.

In one example procedure, embodiments may be configured to store a descriptor dictionary D containing descriptor prototypes μ_k and descriptor identifiers id_k. For an input item x, these embodiments may compute e(x), find the nearest prototype using a deterministic distance metric, and assign the corresponding descriptor identifier if the distance is within a threshold τ. If no prototype is within τ, a new descriptor identifier is allocated deterministically (e.g., monotonic counter or deterministic hash-based allocator) and a new prototype is initialized. Prototype updates may be performed using deterministic update rules (e.g., exponential moving average with fixed coefficients). Descriptor dictionary updates are versioned to preserve reproducibility.

In some embodiments, descriptor assignment includes a stability rule that prevents rapid oscillation of descriptor identifiers for borderline inputs by using deterministic hysteresis thresholds or minimum assignment durations.

### F. Ingestion-Time Explainability Record (IER)

In some embodiments, the ingestion engine generates an IER that explains why the engine assigned modality, sub-modality, descriptors, and sensitivity level. The IER may include:
Rule trace: ordered list of evaluated rules, fired rules, and condition outcomes.
Feature evidence: selected values from s(x) and meta(x) used by rules and/or classifiers.
Ambiguity score A, confidence scores, and tie-break outcomes.
Sensitivity rationale: detector hits, matched patterns, and threshold crossings.
Version identifiers: rule set version, classifier version, threshold version, transform specification version, descriptor dictionary version, and policy version used at ingestion.

The IER may be stored in the ingestion metadata object and may be surfaced to auditing tools, dashboards, or downstream policy modules.

An illustrative IER snippet (non-limiting) is shown below:

{

| | |
|---|---|
| “ier_version”: | “1.3”, |

| | |
|---|---|
| “rule_trace”: | [{“rule_id”:”R-17”,”outcome”:”FIRED”},{“rule_id”:”R- |

21”,”outcome”:”EVALUATED_FALSE”}],

| | | | |
|---|---|---|---|
| “evidence”: | {“sig_dim”:64, | “fft_band_3”:0.82, | “img_thumb_hash”:”a91f...”}, |

| | | | |
|---|---|---|---|
| “ambiguity”: | {“A”:0.12, | “threshold”:0.25, | “early_exit”:true}, |

| | | |
|---|---|---|
| “sensitivity”: | {“level”:”S4”, | “risk”:3.8, |

“contributors”:[“PII_REGEX”,”JURISDICTION_EU”]},

| “tie_break”: | {“method”:”lowest_id”, | | “selected”:”submodality:vibration”}, |
|---|---|---|---|
| “versions”: | {“rules”:”2026.01.12”, | “classifier”:”hat_v5”, | “thresholds”:”thr_9”, |

| | |
|---|---|
| “transforms”:”sigspec_4”, | “policies”:”pol_2026.01”} |

}

### G. Throughput Caching and Deterministic Deduplication

Referring again to FIG. 2, some embodiments of the data ingestion pipeline include throughput cache 212. The throughput cache 212 may store computed modality signatures, assigned tags, descriptor identifiers, and IERs keyed by a hash of c(x) and/or s(x). In some embodiments, the cache supports deterministic deduplication by identifying repeated input items. Cache invalidation may be deterministic and may be based on version changes to state_v (e.g., if a rule set version changes, relevant cache entries are invalidated).

In bursty environments, caching can reduce ingestion latency and stabilize throughput. In some embodiments, caching reduces mean or percentile ingestion latency by at least 30 percent relative to a pipeline without caching, measured over a defined workload and configuration.

### H. Complexity Governor and Bounded Compute Cost

The complexity governor module 210 may be configured to enforce compute budgets. The complexity governor module 210 may control whether to execute optional stages such as the disambiguation classifier, descriptor updates, or expensive feature transforms. The complexity governor module 210 may provide at least two deterministic ingestion modes:

Fast ingestion mode: canonicalization, signature extraction, rule-based tagging, sensitivity assignment, caching, and IER generation, while skipping optional classifier execution and descriptor prototype updates.

Full ingestion mode: fast mode plus optional classifier execution, descriptor assignment and updates, and additional evidence generation.

Mode selection may be deterministic based on observed load, device capacity, allo compute capacity, latency targets, and/or per-batch budgets. The governor may enforce a per-batch time budget by applying deterministic timeouts and fallbacks. Deterministic fallbacks may include assigning a default sub-modality category or deferring descriptor updates to a later batch, while recording the fallback decision in the IER.

### I. Example Deterministic Ingestion Pseudocode

The following pseudocode is illustrative of a deterministic ingestion procedure:

Algorithm 1: DeterministicMultimodalIngest(x, meta, state_v)

```
c <- Canonicalize(x)
if CacheHit(Hash(c), state_v) then return Cache[Hash(c), state_v]
sig <- Signature(c, meta, state_v.signature_spec)
rule_out <- Rule Engine(sig, meta, state_v.rules)
A <- Ambiguity(rule_out)
if A <= state_v.amb_threshold or GovernorMode(state_v) ==
FAST then
  tags <- SelectByDeterministicTieBreak(rule_out, state_v.tie_break)
else
  tags <- Classify(sig, state_v.light_classifier)
end if
sL <- SensitivityScore(c, meta, state_v.sensitivity_spec)
desc <- DescriptorAssign(sig, state_v.descriptor_dict)
ier <- BuildIER(rule_out, sig, meta, A, sL, state_v)
imo <- {tags, sL, desc, sig, ier}
Cache[Hash(c), state_v] <- imo
return imo
```

### J. Compute Complexity Discussion (Non-Limiting)

In some embodiments, the data ingestion pipeline is configured such that the default path does not require executing cross-attention, large-model inference, or high-dimensional embedding generation. Signature extraction and rule evaluation can be implemented with linear or near-linear cost in the size of the input item (e.g., O(n) for scanning a bounded token window or a fixed-size sensor window), and optional classifier execution can be bounded by operating on a fixed-length signature vector. Descriptor assignment can be accelerated using deterministic indexing, and caching further reduces repeated computations. These design choices reduce compute cost compared to pipelines that generate full embeddings or perform fusion at ingestion time merely to identify modality or sensitivity.

### K. Working Example (Non-Limiting)

The following working example illustrates deterministic ingestion and plan enforcement for a mixed-modal input comprising a maintenance log entry (text) and a vibration sensor window (time-series). The example is illustrative and not limiting.

1) Canonicalization. The system normalizes the text to UTF-8 and canonical whitespace and segments the sensor stream into a deterministic 1-second window with a fixed sampling rate. 2) Signature extraction. The system computes a 64-dimensional modality signature including deterministic hashed text features and fixed FFT band energies. 3) Rule tier. A rule set identifies the sensor window as “vibration” with high confidence and identifies the text as “maintenance_log”. 4) Ambiguity gating. Ambiguity A is below threshold and the system exits early without invoking the classifier. 5) Sensitivity. A deterministic detector identifies an equipment serial number (internal) and assigns sensitivity S2. 6) Descriptor assignment. The signature is within threshold of a stored “rotor” descriptor prototype and assigns descriptor id “rotor”. 7) IER. The system records the rule trace, evidence, and versions. The resulting IMO is provided to the orchestrator controller 100.

The orchestrator controller 100 compiles a plan selecting a time-series anomaly model, requests edge execution to satisfy a latency target, and proposes a privacy epsilon of 2.0. The policy module validates the plan and deterministically repairs epsilon to 1.0 for S2 data under an organizational policy, and records the repair action in the audit log 150 prior to execution.

### Structured Orchestration, Plan Compilation, and Deterministic Execution

In some embodiments, the orchestrator controller 100 generates a candidate plan based on IMOs, resource context, and policies. The candidate plan may be proposed by a language model or a rules-based planner. Regardless of how proposed, execution is governed by compiling the candidate plan into a typed structured execution plan (SEP) and validating the SEP under policy and resource constraints.

### A. Structured Execution Plan Schema

In some embodiments, the SEP includes typed fields such as: task identifier; input references; modality tags and sensitivity levels; selected sub-modules; routing and deployment location; privacy parameters (e.g., differential privacy epsilon and delta, noise mechanism, and budget identifiers); explainability schedule; timeouts; and policy metadata. The SEP may be represented in JSON, CBOR, protobuf, or a domain-specific language. The SEP schema is versioned as part of state_v.

An illustrative SEP (non-limiting) is shown below:

{
“task_id”: “T-001”,
“inputs”: [“stream_12”, “log_77”],
“imo_refs”: [“imo_hash_a1”, “imo_hash_b2”],
“tags”: {“modality”: “sensor+text”, “submodality”:
[“vibration”,”maintenance_log”],
“sensitivity”: “S2”, “descriptors”: [“rotor”]},
“routing”: {“location”: “edge”, “latency_ms”: 250, “node_pool”:
“ephemeral_cluster”},
“models”: [{“name”: “timeseries_anomaly_v2”, “role”:
“predict”},
{“name”:”log_summarizer_v1”,”role”:”summarize”}],
“privacy”: {“mechanism”: “gaussian_dp”, “epsilon”: 2.0, “delta”:
1e−5, “budget_id”: “B-17”},
“xai”: {“method”: “streaming_attribution”, “interval_ms”: 200,
“aggregation”: “time_slice”},
“policy”: {“policies”: [“industrial”], “decision”: “PENDING”}}

### B. Plan Compilation

In some embodiments, plan compilation includes schema validation, type checking, reference resolution (e.g., confirming that referenced models exist and accept declared inputs), resource budget checks (e.g., memory and compute limits), privacy budget checks, and generation of an audit log 150. Compilation outputs an executable DAG of operations with parameter constraints.

An illustrative plan compilation procedure is shown below:

Algorithm 2: CompilePlan(candidate plan, state_v)

```
  sep <- ParseAndValidateSchema(candidate_plan, state_v.sep_schema)
  ResolveReferences(sep, state_v.model_registry)
  TypeCheck(sep)
AttachConstraints(sep, state_v.default_constraints)
  dag <- LowerToDAG(sep)
  return (sep, dag)
```

### C. Deterministic Execution and Fallback

In some embodiments, if a candidate plan is unparseable or violates a non-repairable constraint, the system falls back to a deterministic plan template selected based on IMOs and policies. Fallback selection uses deterministic tie-breaking and is recorded in the audit log 150. In some embodiments, execution determinism is supported by fixed plan compilation rules, deterministic scheduling within defined tolerances, and versioned system state.

### D. Audit Logs and Reproducibility

In some embodiments, an audit log 150 records the IMO, SEP, constraint evaluations, repair actions, and execution outcomes. In some embodiments, the audit log 150 further includes ingestion-time explainability (IER) and model-time explainability (e.g., attribution matrices). The audit log 150 enables end-to-end reconstruction of why the system made a routing decision, what constraints were applied, and what repairs were performed.

### Policy Checking, Constraint Compilation, and Deterministic Repair

Referring back to FIG. 1, the policy-checking module 110 validates and, if needed, revises the SEP prior to execution. Policies may include regulatory policies, organizational policies, and technical constraints. Policies and constraints are versioned to support reproducibility.

### A. Policy Repository and Constraint Types

In some embodiments, the policy repository stores at least one policy clause and machine-executable constraints. Constraints may include:
Maximum allowable privacy parameters (e.g., epsilon) for a given sensitivity level.
Required encryption operations for specific sensitivity levels or domains.
Permitted deployment locations or permitted geographic regions for data residency.
Restrictions on specific model components or model versions for certain data categories.
Retention, logging, and audit requirements for regulated workflows.

In some embodiments, constraints are expressed in a declarative constraint language compiled into executable checks over SEP fields.

B. Neural Policy Abstraction (NPA) with Compiled Constraints

In some embodiments, a neural policy abstraction layer stores semantic representations of policy clauses (e.g., embeddings) to support retrieval of relevant clauses given an IMO and candidate SEP. Deterministic enforcement is achieved by compiling retrieved clauses into machine-executable constraints that are evaluated against SEP parameters. In some embodiments, the NPA retrieval step proposes a candidate set of constraints, and a deterministic constraint evaluator determines applicability and compliance.

### C. Deterministic Validation, Conflict Resolution, and Repair

In some embodiments, the policy-checking module 110 performs: (i) applicability determination based on IMOs and context, (ii) constraint evaluation against the SEP, and (iii) deterministic repair of noncompliant parameters. Repair actions may include overriding privacy parameters (e.g., lowering epsilon), changing deployment location (e.g., from cloud to edge), selecting an approved model component, or inserting an additional security operation (e.g., encryption).

In some embodiments, when multiple repairs are possible, the module applies a deterministic repair ordering, such as: (1) enforcing mandatory constraints, (2) reducing or minimizing deviation from candidate plan, (3) reducing or minimizing compute cost, and (4) breaking ties using a stable ordering of repair identifiers. Each repair is recorded with a constraint identifier, a reason code, and the prior and revised parameter values. If a plan cannot be repaired (e.g., no compliant execution environment exists), execution is blocked and an error record is produced.

An illustrative validation and repair procedure is shown below:

Algorithm 3: ValidateAndRepair(sep, imo_set, state_v)

constraints <- SelectConstraints(imo_set, sep, state_v.policy_repo,
state_v.npa)
violations <- Evaluate(constraints, sep)
for v in SortByDeterministicPriority(violations) do
sep <- ApplyDeterministicRepair(v, sep, state_v.repair_catalog)
end for
return sep

### Predictive Sub-Modules and Optional Cross-Modal Fusion

Referring again to FIG. 1, predictive sub-modules 120a, . . . , 120n may include, without limitation: Bayesian inference engines for uncertainty estimation; transformer-based models for text; convolutional models for imaging; time-series models for sensor streams; and fusion modules. The SEP may select a subset of sub-modules and an execution order based on tags, policies, and resource constraints.

In some embodiments, cross-modal fusion may be conditionally invoked. For example, fusion may be invoked only when ingestion tags indicate a correlated multimodal event (e.g., a maintenance log entry with a timestamp correlated to a vibration anomaly and an image of a component). By deferring fusion until justified, these embodiments compute cost relative to always-on fusion pipelines.

In some embodiments, fusion strategies include canonical correlation analysis (CCA) between modality-specific embeddings or cross-attention between modality-specific representations. Fusion strategies may be selected based on latency budgets, device capabilities, and sensitivity levels.

### Real-Time Explainability Aggregation and Optional Causal Linking

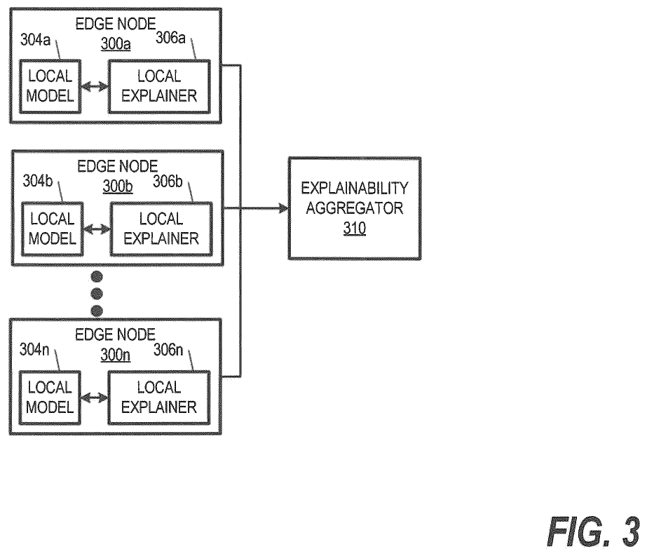

FIG. 3 depicts a sequence for real-time, distributed feature-attribution generation at edge nodes 300a, . . . , 300n and aggregation into a unified explanation output, according to embodiments provided herein. As illustrated, the distributed feature-attribution generation may occur at edge nodes 300a, . . . , 300n and aggregation by an explainability aggregator 310. The plurality of edge nodes 300a, . . . , 300n may include local models 304a, . . . , 304n, and a local explainers 306a, . . . , 306n. The local explainers 306a, . . . , 306n may compute feature-attribution outputs for micro-batches or bounded windows. To reduce compute cost, local explainers 306a, . . . , 306n may use approximation strategies, including sampling-based SHAP, model-specific explainers, cached baselines, incremental updates, and amortized explainers.

In some embodiments, the explainability aggregator 310 merges local attribution vectors into a unified time-slice attribution output. A non-limiting aggregation is a weighted sum of local attributions followed by temporal smoothing. The output may include a machine-readable attribution matrix and optionally a domain-friendly narrative summary. In some embodiments, the narrative summary is generated by the orchestrator controller 100 using the attribution matrix as input while retaining the underlying matrix for verification.

In some embodiments, the explainability output includes both ingestion-time explainability (why the system tagged and routed the input) and model-time explainability (why the model produced an inference output). The combination supports end-to-end interpretability and compliance.

In some embodiments, the explainability aggregator 310 generates causal linking artifacts between modalities by aligning feature identifiers and attention weights, enabling, for example, a textual concept to be linked to an image region or sensor channel. Causal linking may be expressed as a sparse bipartite graph between modality feature sets with edge weights derived from attention or attribution alignment, and such artifacts may be stored with the audit log 150.

### Federated Learning, Differential Privacy, and Ephemeral Edge Clouds

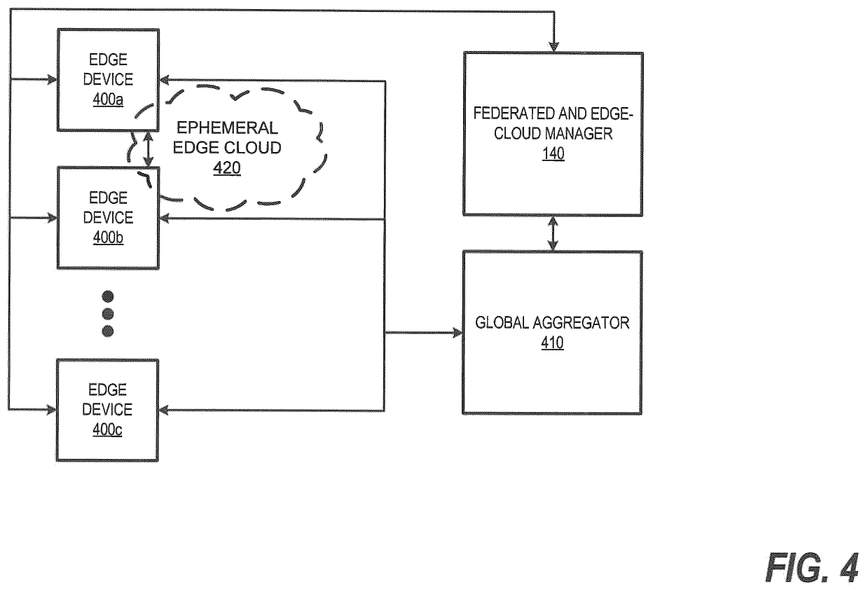

FIG. 4 depicts federated model partitioning and dynamic privacy injection in connection with formation of an ephemeral edge-cloud cluster, according to embodiments provided herein. As illustrated, the federated and edge-cloud manager 140 coordinates distributed inference and training across edge devices 400a, . . . , 400n and a global aggregator 410. The federated and edge-cloud manager 140 may maintain a plurality of model variants, partition models into blocks, and schedule training rounds. The federated and edge-cloud manager 140 may form ephemeral edge clusters to handle bursts in workload or to satisfy latency requirements.

Also provided in FIG. 4 is an ephemeral edge cloud 420. The ephemeral edge cloud 420 is triggered deterministically based on thresholds for data volume, compute load, latency, and/or modality composition. A cluster formation procedure selects candidate nodes, evaluates capacity constraints, establishes secure communication channels, and assigns a cluster identifier. Cluster dissolution may occur when thresholds fall below a defined level. Cluster decisions and membership may be logged for auditability.

In some embodiments, the federated and edge-cloud manager 140 depicted in FIG. 4 corresponds to the federated and edge-cloud manager 140 of FIG. 1. Specifically, the edge devices 400a, . . . , 400n of FIG. 4 represent the distributed processing nodes that execute portions of the validated structured execution plan generated by the orchestrator controller 100 of FIG. 1. The privacy mechanisms (differential privacy noise injection) and the global aggregator 410 of FIG. 4 operate under the policy constraints validated by the policy-checking module 110 of FIG. 1.

In some embodiments, a differential privacy controller may be included and selects privacy parameters as deterministic functions of sensitivity level and remaining privacy budget. For example, for sensitivity level sL, the controller may compute epsilon=f(sL, budget_remaining) according to a versioned policy. The controller may compute a noise scale sigma for a Gaussian mechanism as a deterministic function of epsilon, delta, and an L2 sensitivity bound. Privacy budgets may be tracked using versioned accounting rules, and plan execution may be blocked or modified when a budget is exhausted.

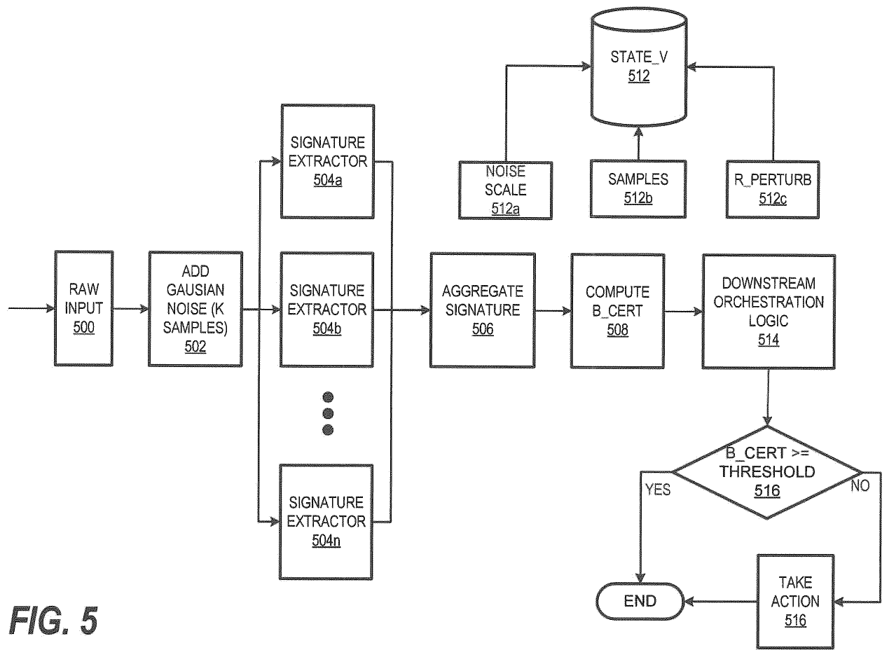

FIG. 5 depicts a robustness certificate flow for deterministic modality signatures, according to embodiments provided herein. As illustrated, some embodiments implement adversarial robustness mechanisms to protect signature extraction against maliciously perturbed or naturally degraded input data. Sensor data, image streams, and other multimodal inputs may undergo adversarial perturbation—whether through intentional manipulation or environmental degradation—that causes misclassification at the ingestion stage (e.g., data ingestion pipeline of FIG. 2). To ensure reliable signature extraction despite such perturbations, the system employs randomized smoothing with formal robustness certificates.

The adversarial robustness mechanism operates as follows. Given raw input 500, also referenced as “x,” (e.g., sensor reading, image frame, or text embedding), embodiments may extract K noisy versions by adding Gaussian noise 502 N (0, sigma\hat{ }2*I) independently tox, where sigma is a versioned noise scale parameter 512a stored in state_v 512. For each noisy input x_i=x+epsilon_i, these embodiments compute a signature s_i in R\hat{ }d using a signature extractor 504a, 504b, . . . , 504n), such as a modality-specific signature extractor (e.g., within data ingestion pipeline of FIG. 2). The K signatures 512b {s_1, . . . , s_K} are aggregated using an aggregate signature module 506 via majority vote (for discrete features) or coordinate-wise median (for continuous features) to produce a final robust signature s_robust.

The robustness guarantee is computed in module 508 via the Neyman-Pearson lemma. Let R denote the adversarial perturbation budget 512c (maximum L2-norm change to input). If the signature function is L₂-Lipschitz (i.e., |f(x)−f(x′)|₂<=L·|x−x′|₂), then the probability that the aggregated signature differs from the clean signature is bounded as: B(R)>=1−2*delta provided that the number of samples K satisfies: K>=(2/R\hat{ }2)*ln(2/delta) where delta is the failure probability parameter (e.g., delta=0.05 for 95% confidence). This bound is stored as a robustness certificate in the ingestion metadata object (IMO), enabling downstream components to reason about signature reliability.

Some embodiments maintain a robustness budget analogous to the compute budget in the complexity governor. This budget quantifies the maximum adversarial perturbation the system will tolerate without degrading signature quality. A versioned parameter robustness_budget_r is stored in state_v. In some embodiments, the robustness budget is adaptive and depends on the sensitivity level of the ingested data. For instance, a sensitivity-dependent robustness policy may specify: If sensitivity>=S4: robustness_certificate B(R)>=0.90 sigma=0.12 K=128 Else if sensitivity>=S2: robustness_certificate B(R)>=0.80 sigma=0.08 K=64 Else: robustness_certificate B(R)>=0.70 sigma=0.05 K=32 All threshold and parameter values (sensitivity levels, sigma, K, target B(R)) are versioned and stored in state_v.

The robustness certificate—the bound B(R)—is stored in the IMO as field robustness_cert_value. This certificate is consulted by downstream orchestration logic 514, particularly the sensitivity assigner and the complexity governor. If a signature's robustness certificate falls below a predetermined threshold in block 516 (e.g., B(R)<0.75), embodiments may take action at block 516, such as raising an alert, requesting re-processing with higher K, and/or applying additional validation steps.

Working Example: Consider an image-based modality processing a video frame from a surveillance camera subject to compression artifacts and potential adversarial patch attacks. The image signature extractor (e.g., deep neural network features) may be vulnerable to small perturbations. To robustify this extraction: 1. The clean frame x is ingested (384×384 RGB image). 2. K=50 noisy versions are generated by adding Gaussian noise N (0, 0.12\hat{ }2*I) to pixel values. 3. For each noisy image, the signature extractor computes a 256-dimensional feature vector. 4. The 50 feature vectors are aggregated via coordinate-wise median. 5. The robustness bound is computed: B (0.15)=1−2*exp (−50*0.15\hat{ }2/(2*0.12\hat{ }2))~=0.94. 6. The median signature and robustness certificate (0.94) are stored in the IMO. 7. Downstream components observe that B (0.15)>0.90, confirming high confidence in the signature.

Algorithm 4: RobustSignatureExtraction (x, sigma, K, state_v) Input: x (raw input, e.g., image/sensor vector) sigma (noise scale, versioned in state_v) K (number of samples, versioned in state_v) state_v (versioned system state) Output: s_robust (aggregated robust signature), B_cert (robustness certificate) 1. signatures←[ ] 2. for i=1 to K: 3. epsilon_i←SampleGaussianNoise(shape=shape(x), scale=sigma) 4. x_noisy←x+epsilon_i 5. s_i←SignatureExtractor(x_noisy, state_v) 6. signatures.append(s_i) 7. end for 8. s_robust←CoordinateWiseMedian(signatures) 9. L_lipschitz←EstimateLipschitzConstant(state_v) 10. R_perturb←LookupPerturbationBudget(state_v) 11. B_cert←max (0, 1−2*exp(−(K*R_perturb\hat{ }2)/(2*sigma\hat{ }2))) 12. return (s_robust, B_cert)

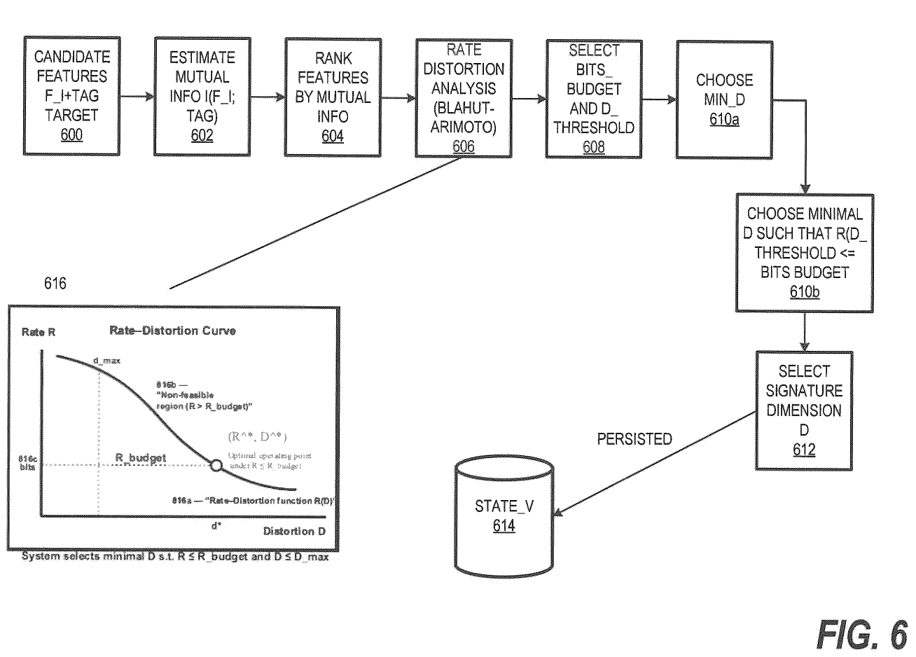

FIG. 6 depicts adaptive signature dimensionality selection using information-theoretic criteria, according to embodiments provided herein. As illustrated, some embodiments justify and optimize the fixed-length dimensionality d of modality signatures using information-theoretic principles. High-dimensional signatures capture fine-grained semantic information but increase storage, transmission, and processing costs. Conversely, low-dimensional signatures reduce costs but may lose discriminative power. These embodiments may employ information-theoretic bounds—specifically mutual information and rate-distortion analysis—to select the minimum signature dimensionality that preserves necessary information about the data tag (label, classification, or metadata).

As illustrated in block 600, some embodiments may compute the mutual information I(f_i; tag) for each proposed feature f_i with respect to the target tag. Mutual information quantifies how much knowledge about the tag is gained by observing feature f_i. A non-parametric k-nearest neighbor (k-NN) estimator—such as the Kraskov-Stögbauer-Grassberger (KSG) estimator—is used in block 602 to estimate mutual information from finite samples: I(f_i; tag)~=psi(k)−<psi(n_x(i))+psi(n_y (i))>+psi (N) where psi is the digamma function, n_x(i) and n_y(i) are k-NN distances along the feature and tag dimensions, and N is the sample count. All parameter values (k value, estimator variant) are versioned in state_v.

In block 604, features are ranked in descending order of mutual information. In block 606, a rate-distortion (R-D) function may be constructed via the Blahut-Arimoto algorithm 616, which iteratively computes the optimal trade-off between compression rate (bits required to encode a signature) and distortion (expected classification error due to information loss). The iterative Blahut-Arimoto procedure maintains a conditional probability distribution p(signature|tag) that balances rate and distortion: Rate R(D)=min {I(signature; tag): E[distortion (tag, signature)]<=D} In some embodiments, the Blahut-Arimoto algorithm is executed offline during system configuration, with results cached in state_v.

Dimension selection proceeds may be performed in block 608 and may include defining a bits_budget parameter (versioned in state_v), representing the maximum number of bits allocated to each signature. The dimensionality d may be chosen in blocks 610a and/or 610b such that the achievable rate R(D_threshold)<=bits_budget, where D_threshold is the maximum tolerable distortion (e.g., classification error<2%). Some embodiments select the minimum d satisfying this constraint.

In some embodiments, the signature dimensionality selected in block 612 and is sensitivity-dependent. Signatures for higher-sensitivity modalities are allocated more bits to preserve fidelity. A sensitivity-dependent dimensionality table, versioned in state_v, may specify: Sensitivity Level S1: min_bits=32, d>=d_S1 Sensitivity Level S2: min_bits=64, d>=d_S2 Sensitivity Level S3: min_bits=96, d>=d_S3 Sensitivity Level S4: min_bits=128, d>=d_S4 Sensitivity Level S5: min_bits=256, d>=d_S5 where d_S1, d_S2, etc., are computed via the rate-distortion optimization above.

In block 614, to enable auditability and future refinement, embodiments may store in an audit log 150 (persisted in state_v): (i) the list of feature indices ranked by mutual information, (ii) the mutual information scores I(f_i; tag) for each selected feature, (iii) the Blahut-Arimoto iteration convergence metrics, and (iv) the achieved classification error rate on a held-out validation set. These logs facilitate forensic analysis and support re-optimization if signature performance degrades.

Working Example: A sensor modality produces 512-dimensional raw readings (e.g., 512 frequency bins from an FFT). The information-theoretic analysis proceeds as follows: 1. Compute mutual information for each of the 512 features with respect to the target tag (e.g., “fault” vs. “normal”): −Bin 23: I=0.87 bits −Bin 45: I=0.72 bits −Bin 112: I=0.65 bits −Bin 256: I=0.42 bits −(remaining 508 bins: I<0.10 bits) 2. Rank features by I(f_i; tag) in descending order. 3. Construct rate-distortion curve via Blahut-Arimoto: −At R=32 bits: distortion=0.08 (8% error) −At R=64 bits: distortion=0.03 (3% error) −At R=96 bits: distortion=0.015 (1.5% error) 4. Set bits_budget=64 and D_threshold=0.05 (5% error). The curve shows R(0.05) ~=60 bits, so select d such that the top d features require ~=60 bits. Suppose the top 48 features achieve this; set d=48. 5. For sensitivity S3 (min_bits=96), increase d to ensure 96-bit capacity, selecting d=64. 6. Store audit log 150: feature indices [23, 45, 112, . . . ], MI scores [0.87, 0.72, 0.65, . . . ], iteration count, and validation error (2.8%).

Algorithm 5: AdaptiveDimensionalitySelection(features, tags, sensitivity_level, state_v) Input: features (N×n_raw matrix; N samples, n_raw raw features) tags (N-dimensional vector of labels) sensitivity_level (S1, S2, S3, S4, or S5) state_v (versioned system state) Output: selected_feature_indices (list of indices), selected_dimensionality d 1. mi_scores←[ ] 2. for i=1 to n_raw: 3. mi_i←KSG_MutualInformation (features [:, i], tags, k=state_v.mi_k_param) 4. mi_scores.append((i, mi_i)) 5. end for 6. mi_scores+Sort(mi_scores, by=second_element, reverse=True) 7. r_d_curve←BlahutArimoto(features, tags, state_v.ba_iterations) 8. bits_min←LookupBitsMin(sensitivity_level, state_v) 9. d_threshold←state_v.d_threshold[sensitivity_level] 10. d←SelectMinDim(r_d_curve, bits_min, d_threshold) 11. selected_indices←[mi_scores [i].index for i in 0 to d−1] 12. LogAudit(selected_indices, [mi_scores[i]. value for i in 0 to d−1], r_d_curve, state_v) 13. return (selected_indices, d)

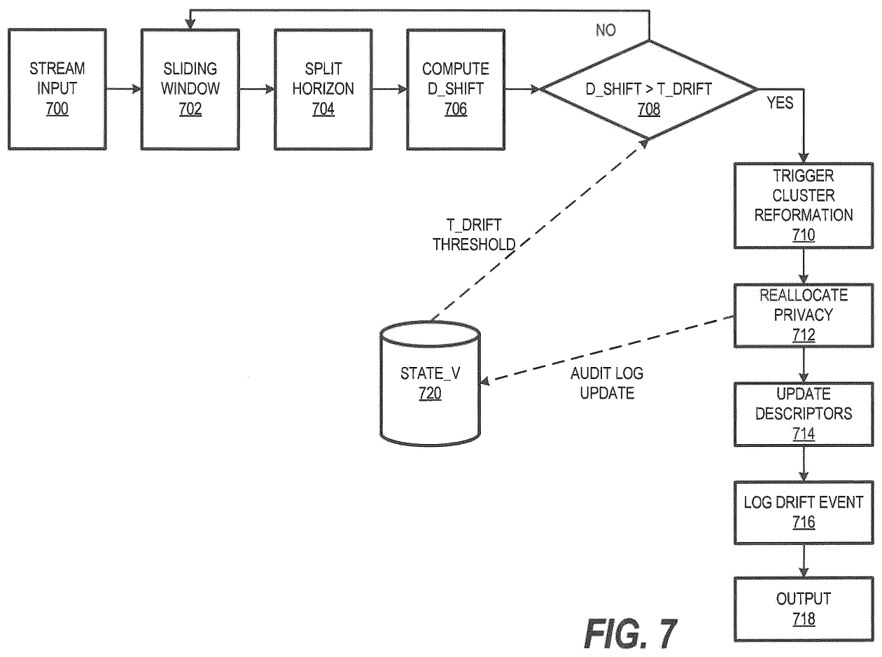

FIG. 7 depicts concept drift detection and descriptor dictionary evolution, according to embodiments provided herein. As illustrated, some embodiments may detect temporal concept drift—systematic changes in the distribution of signatures over time—and trigger cluster reformation to maintain orchestration quality. Sensor degradation, changing environmental conditions, or distribution shift in input data can cause signature distributions to drift. For example, accelerometers may develop bias drift, or image streams may shift from daytime to nighttime conditions. Without drift detection, the cluster assignments, privacy allocations, and descriptor models become stale, degrading performance.

The drift detection mechanism receives stream input at block 700. In block 702, these embodiments maintain a sliding window H of recent signatures from a given modality or sub-modality. The window contains the last T signatures ingested: H={s(x_1), s(x_2), . . . , s(x_T)}, where T is a versioned parameter in state_v. in block 704, the window is partitioned into two temporal halves: H_early (signatures from times 1 to T/2) and H_recent (signatures from times T/2+1 to T).

In block 706, embodiments may compute a distribution shift metric D_shift by comparing the distributions of H_early and H_recent. In some embodiments, the Wasserstein distance (earth mover's distance) is used: D_shift=W_p(P_early, P_recent)=(inf_{gamma} INTEGRAL Is_early-s_recentl\hat{ }p dgamma)\hat{ }(1/p) where the infimum is over all joint distributions gamma coupling P_early and P_recent. In some embodiments, the Kolmogorov-Smirnov (KS) statistic is employed: D_shift=sup_s|F_early(s)−F_recent(s)| where F_early and F_recent are cumulative distributions. All metric parameters (p for Wasserstein, alternative metrics) are versioned in state_v.

Some embodiments may define a drift threshold T_drift (versioned in state_v) that varies by modality type. In block 708, when D_shift exceeds T_drift, cluster reformation is triggered in block 710. Recommended thresholds, reflecting sensitivity to drift, are: Image modality: T_drift=0.15 Sensor modality: T_drift=0.10 Text modality: T_drift=0.20 Audio modality: T_drift=0.12 All thresholds may be versioned and may be updated via state_v versioning mechanisms.

Upon drift detection (D_shift>T_drift), these embodiments may trigger cluster reformation at block 710. This includes: (i) re-clustering the edge nodes 300a, . . . , 300n based on updated signature statistics (e.g., recomputing clusters via k-means or spectral clustering on the recent signatures H_recent), (ii) re-allocating privacy parameters (epsilon, delta budgets) in block 712 according to the new cluster memberships and sensitivity levels, and/or (iii) updating the descriptor dictionary in block 714 to reflect new cluster centroids and prototypes. In block 716, reformations are logged with timestamps, cluster assignments, and new descriptor definitions, enabling auditability and debugging and an output may be generated n block 718.

The audit log 150 entry for a drift event includes: (i) modality identifier, (ii) timestamp, (iii) signature window size T, (iv) D_shift magnitude, (v) T_drift threshold, (vi) list of affected sub-modalities, (vii) new cluster assignments, and (viii) updated privacy parameter allocations. These logs persist in state_v and provide forensic evidence of system adaptation.

Working Example: A vibration sensor mounted on a rotating machine ingests signatures extracted from frequency-domain FFT data. Initially, the frequency band 3 (centered at ~150 Hz) has a mean energy of 0.45 (normalized units). Over 48 hours, mechanical wear causes increasing friction, and the mean energy in band 3 drifts to 0.52. The system's drift detection mechanism: 1. Maintains a sliding window H of the last 500 signatures (T=500, ~5 minutes of data at 100 Hz sampling). 2. Partitions H into H_early (first 250 signatures) and H_recent (last 250 signatures). 3. Computes the Wasserstein distance between the two distributions of band-3 energies: −F_early: mean=0.45, std=0.03 −F_recent: mean=0.52, std=0.04 −W_2(F_early, F_recent)~=0.09 (using optimal transport) 4. Compares to threshold T_drift=0.10 for sensor modality. Since 0.09<0.10, no drift is declared. 5. After additional 24 hours, F_recent has mean=0.58, std=0.05. W_2~=0.14>0.10. Drift is detected. 6. Cluster reformation is triggered: nodes are re-clustered based on band-3 statistics, privacy budgets are rebalanced, and a new descriptor dictionary is computed and logged.

Algorithm 6: DriftDetectionAndReformation(H, T_drift, state_v) Input: H (sliding window of recent signatures) T_drift (drift threshold, versioned in state_v) state_v (versioned system state) Output: drift_detected (boolean), new_cluster_assignment (if drift detected) 1. n_window←length (H) 2. H_early←H[1: n_window/2] 3. H_recent←H[n_window/2+1: n_window] 4. metric_type←state_v.drift_metric_type (e.g., “wasserstein” or “ks”) 5. if metric_type==“wasserstein”: 6. D_shift+WassersteinDistance(H_early, H_recent, p=state_v.wasserstein_p) 7. else if metric_type==“ks”: 8 D_shift←KolmogorovSmirnov(H_early, H_recent) 9. end if 10. drift_detected←(D_shift>T_drift) 11. if drift_detected: 12. LogDriftEvent(H.modality_id, D_shift, T_drift, timestamp=Now( ), state_v) 13. new_clusters←ReCluster(H_recent, state_v.clustering_method) 14. ReallocatePrivacyBudgets(new_clusters, state_v) 15. UpdateDescriptorDictionary(new_clusters, state_v) 16. return (True, new_clusters) 17. else 18. return (False, None) 19. end if

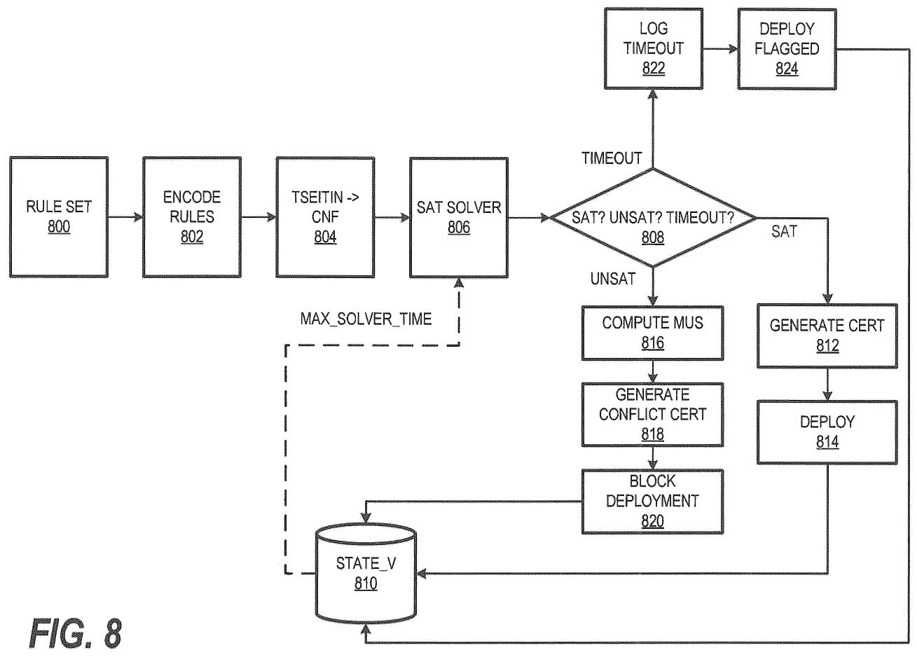

FIG. 8 depicts rule consistency verification using satisfiability checking and minimal conflict sets, according to embodiments provided herein. As illustrated, some embodiments employ Boolean satisfiability (SAT) solving to verify that policy rules are mutually consistent and do not create contradictions or non-deterministic behavior. A rule base may evolve over time, with new rules added to address emerging scenarios. Without consistency checks, conflicting rules may violate system invariants, cause deadlock, or result in non-deterministic policy application. Embodiments may provide formal verification techniques—SAT solving and minimal unsatisfiable subset (MUS) detection—to ensure rule integrity.

In block 800, a rule set may be received. In block 802, each policy rule r_i is encoded as a logical predicate over signature features and metadata attributes. For example: Rule r_1: IF (sensitivity==S4) AND (signature.dimension>=128) THEN (privacy_epsilon<=0.1) Rule r_2: IF (sensitivity==S4) AND (modality==“image”) THEN (privacy_epsilon>0.5) These rules can be formalized in Boolean logic: r_1: (sensitivity_S4 Λ dim_128)→epsilon_low r_2: (sensitivity_S4Λ image)→epsilon_high. A conflict arises if no assignment of variables can satisfy both rules when both conditions hold simultaneously (S4, image, dim_128).

These embodiments convert the rule set to Conjunctive Normal Form (CNF) in block 804 using the Tseitin transformation. The Tseitin procedure introduces auxiliary variables to linearize complex logical formulas, producing an equivalent CNF formula of size linear in the original formula. For example, the rule set above is converted to a CNF formula with clauses such as: (¬sensitivity_S4 ∨ ¬dim_128 ∨ epsilon_low) (¬sensitivity_S4 ∨ ¬image ∨ epsilon_high) (epsilon_low ∨ ¬epsilon_high) [conflict clause, if low and high are mutually exclusive]

The CNF formula is then passed to a CDCL-based SAT solver (e.g., a solver implementing conflict-driven clause learning and backtracking). In block 806, the SAT solver attempts to find a satisfying assignment. If, in block 808, the SAT solver finds a satisfying assignment, the rule set is consistent. If the solver determines the formula is unsatisfiable (UNSAT), the rule set contains conflicts.

To maintain responsiveness, the SAT solver is invoked with a bounded time budget MAX_SOLVER_TIME (e.g., 10 seconds), versioned in state_v. If the SAT solver exceeds this budget without conclusively determining SAT or UNSAT, the system logs a “timeout” event at block 822 and applies a conservative policy: either it deploys the rule set with an “unverified consistency” flag at block 824 (allowing execution but flagging potential risk), or it falls back to a previously verified rule set (the last state_v version known to be consistent).

If the solver determines the rule set is UNSAT, the process computes a minimal unsatisfiable subset (MUS) at block 816, which is the smallest set of rules that are mutually inconsistent. MUS computation is performed via iterative SAT calls: starting with the full rule set, the algorithm removes each rule in turn and checks satisfiability. If satisfiability is restored, that rule is part of the MUS. This greedy procedure identifies the core conflicting rules and generates a conflict certification in block 818, aiding human operators in resolving inconsistencies. The deployment is blocked in block 820 and the MUS is logged in state_v for forensic analysis in block 810. If the solver determines that the rule set is SAT, a certificate is generated in block 812 and deployed in block 814. The certificate is logged in block 810.

A versioned consistency certificate is stored in the audit log 150 (state_v) upon each rule set deployment. The certificate includes: (i) the CNF formula fingerprint (hash), (ii) SAT solver result (SAT/UNSAT), (iii) computation time, (iv) if UNSAT, the MUS and its cardinality, and (v) the versioned rule set identifier. This enables traceability: if a rule-induced failure occurs, operators can correlate it to a specific rule version and verify consistency retroactively.

Working Example: The system defines three rules: Rule A: IF (sensitivity>=S4) THEN (dimensionality>=128 bits) Rule B: IF (deployment==“production”) THEN (sensitivity<=S3) Rule C: IF (dimensionality>=128 bits) AND (deployment==“production”) THEN (sensitivity>=S4) Converting to propositional logic: A: high_sensitivity→high_dim B: production→low_sensitivity C: (high_dim ∨ production)→high_sensitivity A conflict is evident: B requires low_sensitivity in production, but C requires high_sensitivity if high_dim and production. If a modality has high_dim and is deployed to production, C forces high_sensitivity, violating B. Tseitin transformation produces a CNF formula. The CDCL solver determines UNSAT. The MUS is {A, B, C} (all three rules are needed for the conflict). The system logs: consistency_cert: {cnf_hash: “0xabc123 . . . ”, sat_result: “UNSAT”, solver_time_ms: 45, mus_cardinality: 3, mus: [“rule_A”, “rule_B”, “rule_C”], rule_set_version: “v2.3.1”} Operators are alerted to the conflict and must revise the rule set before deployment.

Algorithm 7: VerifyRuleConsistency (rules, state_v) Input: rules (list of logical rules) state_v(versioned system state) Output: is_consistent(boolean), consistency_certificate (dict) 1. cnf_formula←TseitinTransform(rules) 2. cnf_hash←Hash(cnf_formula) 3. max_time←state_v.sat_solver_max_time_ms 4. solver_result, assignment←SATSolve(cnf_formula, timeout=max_time) 5. if solver_result==“SAT”: 6. is_consistent←True 7. mus_cardinality←0 8. mus←None 9. else if solver_result==“UNSAT”: 10. is consistent←False 11. mus←ComputeMUS(cnf_formula, rules) 12. mus_cardinality←length(mus) 13. else: [timeout] 14. is_consistent←None [unknown] 15. mus←None 16. mus_cardinality←−1 17. end if 18. consistency_certificate←{cnf_hash: cnf_hash, sat_result: solver_result, solver_time_ms: TimerElapsed( ), mus_cardinality: mus_cardinality, mus: mus, rule_set_version: state_v.current_rule_version} 19. LogAudit (consistency_certificate, state_v) 20. return (is_consistent, consistency_certificate)

Some embodiments may employ advanced signal processing and time-frequency analysis techniques to extract rich, discriminative signature features from multimodal inputs. Beyond simple statistical moments (mean, variance), these advanced features capture complex signal properties including spectral complexity, multi-scale energy distribution, long-range dependence, and frequency-domain auditory representations. Integration of these features with sensitivity assignment and descriptor allocation enhances the system's ability to distinguish between data classes and adapt processing to data complexity.

Spectral Entropy: Spectral entropy measures the complexity and randomness of a signal's frequency spectrum. Given a power spectral density (PSD) estimated via Welch's method or similar, normalized probabilities P(f_k) are computed for each frequency bin. Spectral entropy is defined as: H_spectral=−ΣP(f_k)*log₂(P(f_k)) High entropy indicates a broadband, noisy signal; low entropy indicates a signal with concentrated energy at specific frequencies. In some embodiments, spectral entropy is incorporated into the signature vector and versioned in state_v as a feature selector toggle.

Wavelet Scaleogram Features: Wavelet transforms decompose a signal into time-frequency components, revealing how spectral content evolves over time. Continuous wavelet transform (CWT) and discrete wavelet transform (DWT) are both employed. From the CWT or DWT coefficient matrix (scales×time), the system computes: (i) energy per frequency band (integration of squared coefficients across time for each scale), (ii) peak locations and magnitudes (identifying transient events), and (iii) temporal localization metrics. These features capture multi-scale structure and are particularly valuable for non-stationary signals (e.g., speech, vibration). Wavelet mother function (e.g., Morlet, Mexican hat) and scale range are versioned in state_v.

Hurst Exponent: The Hurst exponent H in (0, 1) quantifies long-range dependence and self-similarity in time series. H is estimated via rescaled range (R/S) analysis or detrended fluctuation analysis (DFA): H~=slope (log(rescaled_range) vs. log(lag)) Values H<0.5 indicate mean-reverting behavior, H~=0.5 indicate random walk, and H>0.5 indicate persistent trending behavior. The Hurst exponent is versioned as a feature toggle in state_v and included in signatures for sensor and time-series modalities.

Mel-Frequency Cepstral Coefficients (MFCCs): MFCCs are widely used features in audio and speech processing. The computation proceeds as: (i) apply a triangular mel-scale filterbank to the power spectrum, (ii) compute logarithm of mel-scale powers, and (iii) apply discrete cosine transform (DCT). The resulting MFCC vector typically contains 13 coefficients. For signature extraction, the system computes mean and variance of each MFCC coefficient across multiple audio frames, yielding 26 features. All MFCC parameters (number of filters, frequency range, DCT order) are versioned in state_v.

Integration of these advanced features with sensitivity assignment and descriptor allocation is as follows. When the sensitivity assigner (e.g., within data ingestion pipeline of FIG. 2) classifies an input as belonging to a high-sensitivity modality, it allocates a larger descriptor pool and more precision bits. Signatures incorporating advanced features (spectral entropy, wavelet energy bands, Hurst exponent, MFCCs) are more expressive and better utilize this extended descriptor space. In some embodiments, the descriptor assigner (e.g., within data ingestion pipeline of FIG. 2) selects descriptor prototypes with higher diversity when advanced features are present, improving cluster representativeness.

Parameters controlling advanced feature extraction—spectral window size, wavelet mother function, DFA embedding dimension, MFCC filter count—are stored and versioned in state_v. Changes to these parameters trigger re-computation of signatures for historical data (if available), enabling adaptation to new modality characteristics or discovery of improved feature sets.

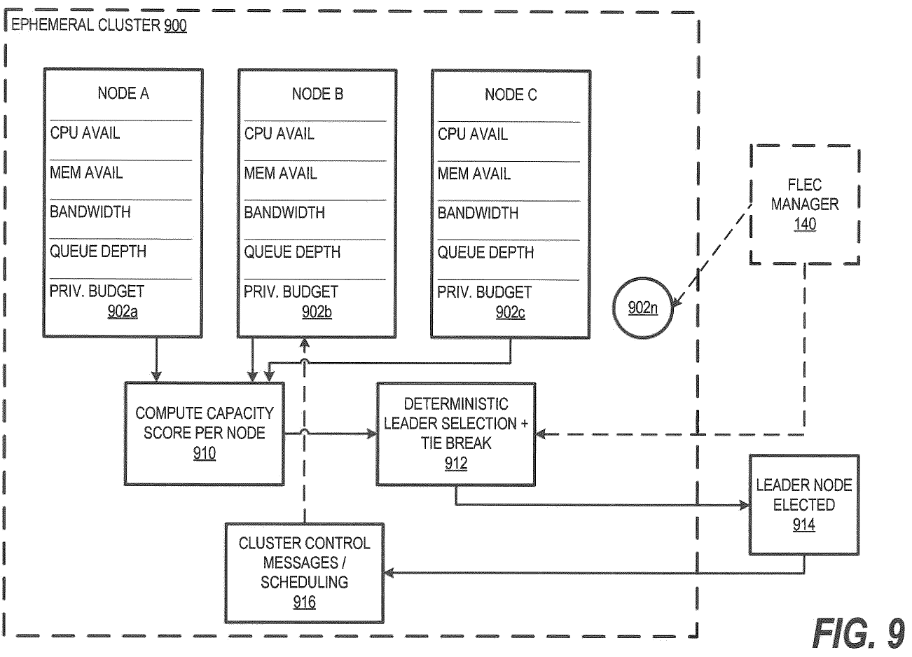

FIG. 9 depicts capacity-aware leader election and privacy-budget-aware cluster control, according to embodiments provided herein. Some embodiments perform leader election within an ephemeral cluster 900 using a capacity-aware scoring function, rather than traditional deterministic metrics (e.g., lowest node ID). Traditional election schemes ignore computational and networking capacity, potentially assigning leadership to a resource-constrained node, creating bottlenecks. The capacity-aware approach selects the node best positioned to coordinate cluster activities given its current resource utilization.

The capacity score for each candidate node 902a, . . . , 902n is computed at block 910 as a weighted combination of resource utilization metrics, all versioned in state_v: capacity_score(node)=w₁·cpu_available+w₂·memory_available−w₃·queue_length−w₄·bandwidth_used where: −cpu_available: percentage of CPU not in use (0-100%)−memory_available: percentage of RAM not in use (0-100%)−queue_length: number of pending tasks waiting in the node's processing queue−bandwidth_used: network bandwidth currently utilized (in Mbps or normalized units)—w₁, w₂, w₃, w₄: versioned weights reflecting priorities. For example, in a bandwidth-constrained edge environment, w₄ may be elevated to deprioritize bandwidth-saturated nodes. In compute-intensive applications, w₁ may dominate.

The node 902a, . . . , 902n with the highest capacity_score is elected leader at block 912. Ties are broken deterministically using the node's identifier (e.g., lexicographic order of node UUID), ensuring that election is reproducible and audit-friendly. The election decision in block 914, including all candidate nodes' scores, tie-break method, and elected leader, is logged with a timestamp in state_v, providing forensic evidence of the election process.

In some embodiments, a privacy-budget-aware variant of capacity-aware leader election is implemented. In this variant, the score incorporates remaining privacy budget allocation (e.g., residual epsilon): capacity_score (node)=w₁·cpu_available+w₂·memory_available−w₃·queue_length+w₅·remaining_epsilon/epsilon_total This variant prioritizes nodes with substantial privacy budget remaining, ensuring that privacy-sensitive tasks are routed to nodes with capacity for privacy-preserving mechanisms. At block 916, cluster control messages and scheduling of nodes 902a, . . . , 902n may be received and/or determined.

Working Example: An ephemeral cluster comprises three edge nodes 300a, . . . , 300n processing sensor data from industrial equipment. At a given moment: Node A: cpu=45%, mem=60%, queue=8, bw=120 Mbps Node B: cpu=80%, mem=75%, queue=2, bw=45 Mbps Node C: cpu=10%, mem=30%, queue=15, bw=200 Mbps With weights w₁=0.30, w₂=0.25, w₃=0.20, w₄=0.25: score_A=0.30·45+0.25·60−0.20·8−0.25·120=13.5+15−1.6−30=−3.1 score_B=0.30·80+0.25·75−0.20·2−0.25·45=24+18.75−0.4−11.25=31.1 score_C=0.30·10+0.25·30−0.20·15−0.25·200=3+7.5−3−50=−42.5 Node B is elected leader (highest score). The election is logged: election_log: {timestamp: 2025-01-15T14: 32:17Z, cluster_id: “ephemeral_cluster_789”, candidates: [{node_id: “A”, score: −3.1}, {node_id: “B”, score: 31.1}, {node_id: “C”, score: −42.5}], elected leader: “B”, tie_break_method: “lexicographic”}

Algorithm 8: CapacityAwareLeaderElection (candidate_nodes, state_v) Input: candidate_nodes (list of node objects with resource metrics) state_v (versioned system state) Output: elected_leader (node object), election_log (dict) 1. scores←[ ] 2. w1←state_v.capacity_weight_cpu 3. w2←state_v.capacity_weight_memory 4. w3←state_v.capacity_weight_queue 5. w4←state_v.capacity_weight_bandwidth 6. for each node in candidate_nodes: 7. cpu_avail←PercentageAvailable(node.cpu_used, node.cpu_total) 8. mem avail←PercentageAvailable(node.mem_used, node.mem_total) 9. queue_len←QueueLength(node.task_queue) 10. bw_used←NetworkBandwidthUsed(node) 11. score←(w₁*cpu_avail+w₂*mem avail−w₃*queue_len−w₄*bw_used) 12. scores.append({node: node, score: score}) 13. end for 14. scores←Sort(scores, by=score, reverse=True) 15. elected_leader←scores[0].node 16. if length (scores)>1 and scores [0].score==scores [1].score: 17. [tie detected; apply deterministic tie-break] 18. elected leader←BreakTieDeterministically([s.node for s in scores if s.score==scores [0].score]) 19. end if 20. election_log←{timestamp: Now( ) cluster_id: state_v.ephemeral_cluster_id, candidates: [{node_id: s.node.id, score: s.score} for s in scores], elected leader: elected_leader.id, tie break_method: “lexicographic”} 21. LogAudit (election_log, state_v) 22. return (elected_leader, election_log)

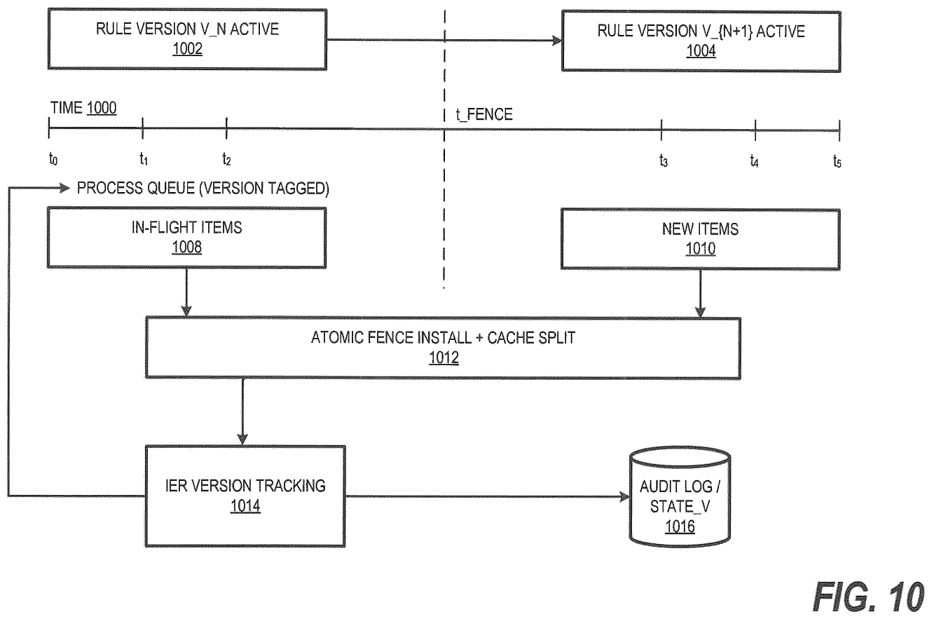

FIG. 10 depicts a rule version migration protocol with version fences for in-flight processing, according to embodiments provided herein. As illustrated, some embodiments implement a rule version migration protocol to ensure deterministic, safe transitions when the rule set is upgraded from version v_n to v_{n+1}. Without such a protocol, in-flight items (data currently undergoing orchestration) may be processed under inconsistent rule versions, leading to non-deterministic behavior and inconsistency.

The migration problem arises as follows. At time t=T, rule set v_n is active at block 1002 and processing a queue of in-flight items. At time t=T+ΔT, an operator deploys rule set v_{n+1} block 1004. Items that entered the queue before T should be processed entirely under v_n rules, while items entering after T should be processed under v_{n+1} rules. If migration is not controlled, some in-flight items 1008 may have portions processed under v_n and portions under v_{n+1}, causing inconsistency.

The solution is a version fence—an atomic marker that separates items processed under v_n from items processed under v_{n+1}. At deployment time, the system: (i) records the current rule version v_n as the “fence version,” (ii) marks all items currently in queues as “fence_version=v_n,” (iii) atomically swaps the active rule set to v_{n+1} (block 1004), and (iv) all newly entering items (block 1010) are marked “fence_version=v_{n+1}.” Items are routed through orchestration logic using the rule version specified by their fence_version marker. The operation is atomic fence install, plus a cache split at block 1012 to prevent race conditions.

Fence Implementation: The version fence is implemented via an atomic read-modify-write operation on a versioned state variable fence_version_id in state_v. At migration time: ATOMIC_OPERATION: 1. fence_version_id_old←Read(state_v.fence_version_id) 2. [wait for queue to drain: all items marked fence_version_old complete] 3. fence_version_id_new←fence_version_id_old+1 4. Write(state_v.fence_version_id, fence_version_id_new) 5. Write(state_v.active_rules, rules_v_{n+1}) END_ATOMIC_OPERATION Depending on the system's deployment model (single-process, distributed), atomicity is enforced via mutexes, compare-and-swap (CAS) operations, or distributed consensus (e.g., Paxos, Raft).

Cache Invalidation: When rule version migration occurs, any cached results keyed by the old state_v version must be invalidated. The caching layer maintains cache entries with format: (input_hash, state_v_version)→cached_output. Upon version migration, entries with state_v_version<fence_version_id_new are evicted. This prevents incorrect cache hits in which new rules are applied to cached outputs computed under old rules.

IER Version Tracking block 1014: The ingestion-time explainability record (IER) for each item includes a field fence_version that records which rule version was active at the item's ingestion time. This enables forensic analysis: if a rule-induced failure occurs, operators can query the IER to determine which rule version was active and cross-reference the failure to specific rule changes. This data is communicated to the audit log 150 and/or state_v at block 1016.

Example Sequence: t=0: rule set v_42 is active. Items A, B, C enter queue and are marked fence_version=42. Items A, B complete under rules v_42. Item C is in-flight. t=10 s: Operator deploys rule set v_43. Atomic fence operation: fence_version_id_old=42, fence_version_id_new=43. All entries in cache keyed by state_v_v_42 are evicted. Rules in state_v are updated to v_43. t=10.5 s: Item C completes (using rules v_42, as required by its fence_version). Item D enters queue and is marked fence_version=43. t=15 s: Item D completes under rules v_43. Forensic log: Item A: fence_version=42 [completed] Item B: fence_version=42 [completed] Item C: fence_version=42 [completed] Item D: fence_version=43 [completed] All items are processed under their designated rule version, maintaining consistency.

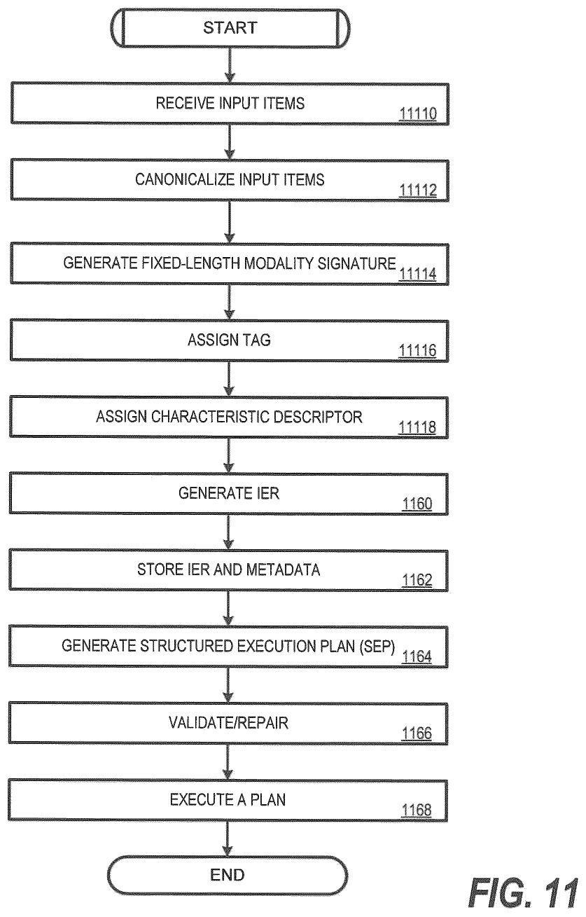

FIG. 11 depicts a flowchart for providing an adaptive multimodal artificial intelligence (AI) orchestration framework, according to embodiments provided herein. As illustrated in block 1110, some embodiments may receive input items. Specifically, some may be configured to receive a plurality of input items formatted according to at least two different modalities. The different modalities may include at least text, image, audio, video, and/or sensor-stream data. In block 1112, the input items may be canonicalized to form a canonical representation. In block 1114, a modality signature may be computed using a predetermined set of deterministic feature transforms. In block 1116, a characteristic may be assigned. As an example, deterministic hierarchical tagging function may be assigned to the modality signature to assign at least one of the following: (i) a modality identifier, (ii) a sub-modality identifier, (iii) one or more descriptor identifiers, and/or (iv) a sensitivity level selected from a plurality of ordered sensitivity levels. In block 1118, an explainability record may be generated. In some embodiments, an ingestion-time explainability record is generated that includes a rule identifier, a rule trace, a feature evidence value, an ambiguity score, a deterministic tie-break outcome, and/or a version identifier associated with the deterministic hierarchical tagging function.

In block 1160, the at least one characteristic and the explainability record may be stored. In some embodiments, the modality identifier, the sub-modality identifier, the one or more descriptor identifiers, the sensitivity level, and the ingestion-time explainability record in an ingestion metadata object may be stored. In block 1162, an execution plan may be generated. Specifically, the ingestion metadata object may be provided to an orchestrator controller 100 configured to generate and compile a typed structured execution plan that is represented in a typed schema specifying at least a model selection, a deployment location, and/or a privacy parameter. In block 1164, the execution plan may be validated, such as with a policy-checking module 110 by evaluating one or more machine-executable policy constraints and/or a set of versioned policy constraints. In block 1166, a noncompliant plan parameter may be repaired. In some embodiments, the policy-checking module 110 may deterministically repair at least one noncompliant plan parameter to satisfy a violated policy constraint and recording the repair in an audit log 150. In block 1168, a model may be executed. In some embodiments, at least one predictive or generative model may be execute in accordance with the validated structured execution plan to produce an inference output and an explanation output.

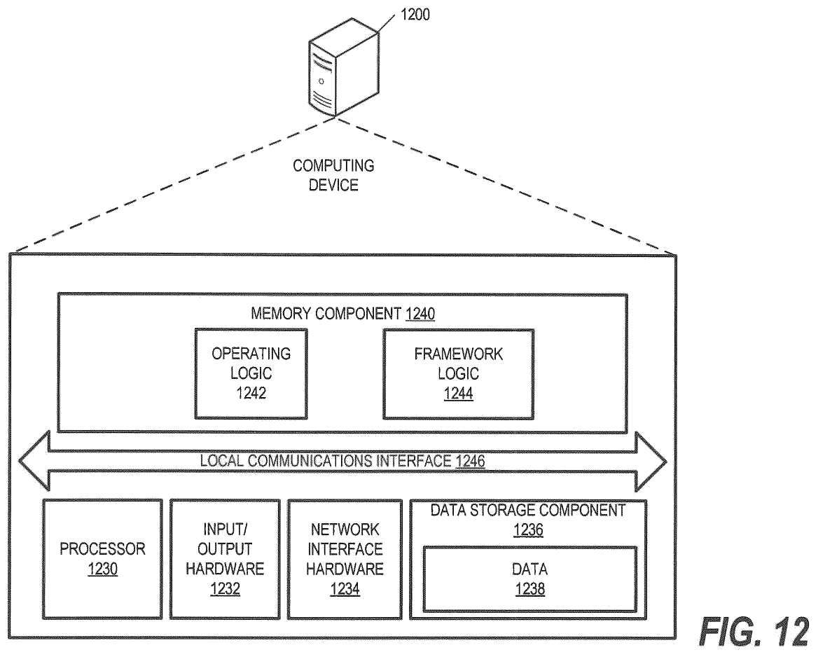

FIG. 12 depicts an example computing device 1200 including a processor 1230, input/output hardware 1232, network interface hardware 1234, data storage component 1236 storing data 1238, memory component 1240, and local communications interface 1246. The memory component 1240 may represent any non-transitory computer-readable storage medium and stores computer-executable instructions, such as operating logic 1242 and framework logic 1244 that, when executed by processor 1230, implements one or more modules described herein (e.g., ingestion pipeline (FIG. 2), orchestrator controller 100, policy-checking module 110, explainability aggregator 130, and federated learning and edge-cloud manager 140). In some embodiments, modules are distributed across multiple computing devices.

### Technical Improvements

Embodiments described herein provide technical improvements to the technical field of machine learning and to computing systems that ingest heterogeneous multimodal data and execute AI workflows under latency and compliance constraints. Non-limiting examples of improvements include: (i) deterministic and versioned ingestion-time tagging and sensitivity assignment enabling reproducibility; (ii) compute-bounded ingestion using low-cost signatures, early-exit gating, and caching; (iii) typed plan compilation and policy validation prior to execution, enabling deterministic enforcement of constraints; and (iv) generation of ingestion-time and model-time explanation artifacts that are time-synchronized across modalities, enabling auditability.

### Example Use Cases (Non-Limiting)

Healthcare. Inputs may include clinical notes, medical images, and physiologic sensor streams. Deterministic ingestion tags may assign high sensitivity levels to protected health information and may cause the policy-checking module 110 to require execution within a compliant environment and to enforce stricter privacy parameters. Ingestion-time explainability records may support compliance audits by documenting why a record was tagged as sensitive and which rules and detectors were applied.

Manufacturing. Inputs may include vibration sensor streams, equipment images, and maintenance logs. The ingestion pipeline may determine that most events can be handled using a low-cost unimodal time-series model and may invoke cross-modal fusion only when justified by tags and context. Throughput caching may stabilize the pipeline during bursts.

Renewable energy. Inputs may include drone images, LIDAR data, and weather logs. Ephemeral edge clusters may form to process imaging bursts while maintaining policy-compliant routing. Time-slice feature-attribution outputs may highlight evolving anomaly contributors over time.

As used herein, the following terms may adopt the following meanings:

“Deterministic” means that the ingestion outputs and compiled execution plan are reproducible across executions when executed using the same versioned system state (state_v) and deterministic tie-breaking, wherein version identifiers used for ingestion, tagging, compilation, validation, and repair are recorded in an evidence record (e.g., ingestion-time explainability record and audit log 150 with a repair reason code) to enable replay and audit of the decision process.

“Explainable” means that evidence artifacts are produced that justify ingestion decisions (e.g., modality, sensitivity, descriptors) and/or orchestration decisions (e.g., routing, deployment, privacy parameters).

“Resource-efficient” means bounding compute and memory consumption by using low-cost feature transforms, early-exit gating, caching, and/or compute budgeting.

An “input item” may include a single datum, a batch, and/or a bounded window of a stream. Input items may include, without limitation, textual messages, unstructured documents, images, video frames, audio segments, and time-series sensor windows. An input item may be associated with metadata such as timestamps, device identifiers, jurisdiction labels, data residency labels, user/session identifiers, or encryption status.

A “canonical representation” c(x) is a deterministic normalization of an input item x. Canonicalization (or canonicalizing) reduces incidental variation and stabilizes downstream computations such as signatures and cache keys.

A “modality signature” s(x) is a fixed-length vector or bitstring computed deterministically from the canonical representation c(x) using a predetermined set of feature transforms. The modality signature may be configured to be computationally inexpensive relative to high-dimensional embeddings or cross-modal fusion and to support caching, tagging, similarity evaluation, and descriptor assignment.

An “ingestion metadata object” (IMO) is a structured data object associated with an input item and comprising (i) at least one modality identifier, (ii) at least one sub-modality identifier, (iii) at least one sensitivity level, (iv) one or more descriptor identifiers, (v) at least one modality signature, and/or (vi) at least one ingestion-time explainability record.

An “ingestion-time explainability record” (IER) is a structured evidence record explaining ingestion-time decisions. In some embodiments the IER includes: (i) an ordered rule trace, (ii) feature evidence values, (iii) ambiguity and confidence measures, (iv) deterministic tie-break outcomes, and/or (v) provenance identifiers, including versions of rule sets, thresholds, transform specifications, descriptor dictionaries, models, and policies used during ingestion.

A “structured execution plan” (SEP) is a machine-readable plan that specifies an executable directed acyclic graph (DAG) of operations to be executed, which may include typed operations, such as including typed parameters, declared inputs/outputs, and validation constraints. In some embodiments, candidate plans may be proposed by an agent or language model; however, plan execution is governed by compilation and validation of the SEP.

A “policy constraint” is a machine-executable condition applied to SEP parameters, such as permitted deployment regions, required encryption operations, maximum allowable privacy parameters, or restrictions on model components.

“Deterministic repair” is a deterministic modification to a candidate SEP performed to satisfy one or more violated policy constraints, such as overriding a parameter value, substituting an approved component, or inserting a required operation.

A “versioned system state” state_v includes versions of (i) canonicalization procedures, (ii) signature specifications, (iii) rule sets, (iv) classifier weights, (v) thresholds, (vi) descriptor dictionaries, (vii) policy repositories, and/or (viii) plan schemas. Versioning supports reproducibility and auditability.

While particular embodiments and aspects of the present disclosure have been illustrated and provided herein, various other changes and modifications can be made without departing from the spirit and scope of the disclosure. Moreover, although various aspects have been provided herein, such aspects need not be utilized in combination. Accordingly, it is therefore intended that the appended claims cover all such changes and modifications that are within the scope of the embodiments shown and provided herein.

It should now be understood that embodiments disclosed herein include systems, methods, and non-transitory computer-readable mediums for providing an adaptive multimodal AI orchestration framework. It should also be understood that these embodiments are merely exemplary and are not intended to limit the scope of this disclosure.

Ephemeral Edge Cluster: A temporary grouping of edge nodes 300a, . . . , 300n formed dynamically based on deterministic proximity, resource availability, or task affinity thresholds. Clusters are instantiated when multiple nodes meet formation criteria (e.g., network latency<50 ms, resource utilization<80%) and dissolved when criteria no longer hold (e.g., a node becomes unreachable, resource utilization exceeds threshold). The lifecycle of each ephemeral cluster—formation timestamp, node membership, dissolution timestamp—is logged in state_v for auditability and forensic analysis. Clustering decisions are reproducible given the same system state and input conditions, enabling validation and replay.

Privacy Budget: A cumulative limit on the privacy loss (measured in differential privacy terms as epsilon, delta) that a modality or task may incur across all orchestration operations. The privacy budget is versioned and stored in state_v. The system tracks cumulative privacy cost (sum of epsilons/deltas of all applied privacy mechanisms) and blocks execution of new operations when the remaining budget would be exhausted. For example, if a modality is allocated epsilon_total=1.0, and current operations have consumed 0.85, a new operation requesting epsilon=0.2 is blocked because 0.85+0.2>1.0. Privacy budgets are sensitivity-dependent and may be refreshed or adjusted through state_v versioning.

Hard Constraint: A logical constraint that must be satisfied for the system to proceed. Violation of a hard constraint results in immediate blocking of the operation and escalation to a human operator or fallback protocol. Hard constraints include: (i) consistency constraints (rule sets must be SAT-verifiable), (ii) privacy constraints (cumulative epsilon<epsilon_total), (iii) capacity constraints (total processing load<available compute), and (iv) safety constraints (no operation on data classified as unlabeled or untrusted without explicit approval). Hard constraints are defined in state_v and enforced at all decision points.

Soft Constraint: A preference or guideline that should be satisfied when feasible but may be relaxed if necessary to achieve core functionality. Soft constraints include: (i) cost optimization goals (minimize cloud transmission), (ii) latency targets (process within T_max milliseconds), and (iii) descriptor reuse (prefer existing descriptors over creating new ones). Violation of soft constraints triggers logging and may affect service-level objective (SLO) metrics, but does not block operation. Soft constraints and their relax priorities are versioned in state_v.

Repairable Constraint: A constraint that is initially unsatisfiable but may be made satisfiable by modifying signature extraction parameters. For example, a rule requiring dimensionality>=256 bits for S5 sensitivity may be violated if the current signature extraction parameters allocate only 128 bits. This is a repairable constraint: the system may increase the allocated bits via state_v parameter adjustment, re-extracting signatures to satisfy the constraint. Repairable constraints are distinguished from hard constraints by attempting signature extraction parameter repair before blocking.

Emergent Descriptor Protocol: A deterministic, stateless procedure by which the system identifies novel data types not represented in the current descriptor dictionary and generates new descriptor prototypes. When an ingested modality's signature does not closely match any existing descriptor (distance>similarity_threshold), the protocol: (i) increments a “novelty counter” in the ingestion metadata object (IMO), (ii) if novelty counter exceeds a threshold N_threshold, classifies the modality as emergent, (iii) extracts a diverse set of K_new representative signatures, (iv) clusters them and selects K_new/n_clusters prototypes, (v) computes a new descriptor entry with centroid, covariance, and metadata, and (vi) appends the entry to the descriptor dictionary and increments state_v version. The protocol ensures that new data types are discovered and documented reproducibly.

Robustness Certificate: A formal upper bound B(R) in [0, 1] on the probability that a signature remains unchanged (under coordinate-wise median aggregation) when the input is adversarially perturbed by at most L2-norm R. Robustness certificates are derived via randomized smoothing and the Neyman-Pearson lemma. A high robustness certificate (e.g., B(0.15)=0.94) indicates strong confidence that the signature is reliable despite input perturbations. Robustness certificates are stored in the ingestion metadata object (IMO) and consulted by downstream orchestration logic to validate signature quality.

Concept Drift: A systematic change in the distribution of signatures extracted from a modality or sub-modality over time, detected via statistical hypothesis tests (Wasserstein distance, KS statistic, or other distribution divergence measures). Concept drift may result from sensor degradation, changing environmental conditions, or natural distribution shift in input data. When drift is detected (D_shift>T_drift), the system triggers cluster reformation and updates descriptor dictionaries. Drift events are logged with timestamp, magnitude, affected sub-modalities, and reform actions.

Minimal Unsatisfiable Subset (MUS): The smallest set of logical clauses (rules) such that no variable assignment can satisfy all clauses simultaneously (i.e., the subset is unsatisfiable). MUS is used to identify the root causes of rule inconsistency. Computation of MUS proceeds via iterative SAT calls: for each clause, the MUS algorithm checks whether removing that clause restores satisfiability. All clauses that must be removed to restore satisfiability form the MUS. MUS is reported in consistency certificates and aids human operators in diagnosing and resolving rule conflicts.

As used herein, an “ephemeral edge cluster” is a transient grouping of two or more computing nodes formed in response to a deterministic triggering condition (e.g., observed load exceeding a threshold, latency exceeding a threshold, or a particular modality composition) and dissolved when the triggering condition no longer holds, wherein membership, cluster identifiers, and formation and dissolution decisions are recorded for auditability.

As used herein, a “privacy budget” is an accounting quantity representing cumulative differential-privacy consumption (e.g., epsilon and delta values) allocated per dataset, user, session, task, or time window, wherein remaining budget is decreased by executed operations and enforcement blocks or modifies execution when the remaining budget would be exceeded.

As used herein, a “hard constraint” is a policy constraint that blocks execution when violated. A “soft constraint” is a policy constraint that permits execution while recording a violation. A “repairable constraint” is a policy constraint for which a deterministic repair action is defined in a repair catalog, enabling modification of a structured execution plan to satisfy the constraint without blocking execution.

As used herein, an “emergent descriptor protocol” is a deterministic procedure for allocating an emergent descriptor identifier when input items do not match existing descriptors, initializing descriptor prototypes, updating prototypes using fixed update rules (e.g., exponential moving average with a fixed decay), and versioning a descriptor dictionary to preserve reproducibility across executions.

As used herein, “deterministic” means reproducible across executions when executed using the same versioned system state (state_v) and deterministic tie-breaking, wherein version identifiers used for ingestion, tagging, compilation, validation, and repair are recorded in an evidence record (e.g., ingestion-time explainability record and audit log 150) to enable replay and audit of the decision process.

As used herein, a “verification result identifier” is a structured record produced by a rule consistency verification procedure, comprising at least (i) a fingerprint or hash of the logical formula (e.g., CNF) derived from the rule set, (ii) the satisfiability solver result (e.g., satisfiable, unsatisfiable, or timeout), (iii) the solver computation time, (iv) any identified minimal conflict set (if the result is unsatisfiable), and (v) a versioned rule set identifier linking the certificate to a specific rule set version in state_v. The verification result identifier is stored in the audit log 150 to support forensic analysis and traceability of rule deployments.

As used herein, a “minimal conflict set” is the smallest subset of policy constraints (rules) within a constraint set such that no assignment of variables can simultaneously satisfy all constraints in the subset, identified via a satisfiability check in which each constraint is tentatively removed to determine whether satisfiability is restored. A minimal conflict set is reported in a verification result identifier and aids operators in diagnosing and resolving policy conflicts prior to rule deployment.

Therefore, at least the following is claimed:

1. A method for providing an adaptive multimodal artificial intelligence (AI) orchestration framework comprising:
receiving a plurality of input items formatted according to at least two different modalities;
canonicalizing the plurality of input items to form a canonical representation;
computing, from the canonical representation, a modality signature using a predetermined set of deterministic feature transforms;
applying a deterministic hierarchical tagging function to the modality signature to assign at least one characteristic comprising at least one of the following: a modality identifier, a sub-modality identifier, at least one descriptor identifier, or a sensitivity level selected from a plurality of ordered sensitivity levels;
generating an ingestion-time explainability record comprising at least one of the following: a rule identifier, a rule trace, a feature evidence value, an ambiguity score, a deterministic tie-break outcome, or a version identifier associated with the deterministic hierarchical tagging function;
storing the at least one characteristic and the ingestion-time explainability record in an ingestion metadata object;
providing the ingestion metadata object to an orchestrator controller configured to generate and compile a typed structured execution plan specifying at least a model selection, a deployment location, and a privacy parameter, wherein the orchestrator controller selects at least one plan parameter based on the at least one characteristic stored in the ingestion metadata object;
evaluating, by a policy-checking module, at least one machine-executable policy constraint against the typed structured execution plan;
deterministically repairing, by the policy-checking module, at least one noncompliant plan parameter of the typed structured execution plan to satisfy a violated policy constraint prior to execution, and recording the repair in an audit log comprising at least a violation identifier and a repair reason code; and
executing, in accordance with the typed structured execution plan, at least one predictive or generative model to produce an inference output and an explanation output associated with the ingestion-time explainability record.

2. The method of claim 1, wherein canonicalizing the plurality of input items comprises normalizing encoding of text data, normalizing an orientation or color space of image data, normalizing an audio sampling rate, or resampling sensor-stream data into deterministic time windows.

3. The method of claim 1, wherein the modality signature comprises a fixed-length vector generated via deterministic feature hashing or a fixed-length bitstring generated via a deterministic locality-sensitive hash.

4. The method of claim 1, wherein applying the deterministic hierarchical tagging function comprises at least one of the following:
executing a versioned rule engine and producing the rule trace that identifies rules evaluated by the versioned rule engine as part of the ingestion-time explainability record; or
responsive to the ambiguity score exceeding a threshold, executing a learned classifier operating on the modality signature, wherein determinism is enforced by fixed model parameters and deterministic tie-breaking for equal classifier scores.

5. The method of claim 1, further comprising:
computing a deterministic risk score as a weighted combination of at least two of the following: a personally identifiable information indicator, a domain indicator, a residency indicator, a novelty indicator, and an encryption-state indicator, and mapping the deterministic risk score to the plurality of ordered sensitivity levels using a deterministic threshold;
assigning an emergent descriptor identifier using a deterministic online bucketing or clustering procedure operating on a low-dimensional projection of the modality signature, and storing the emergent descriptor identifier in the ingestion metadata object;
caching a result of at least one of the following: computing, applying, or generating in a cache keyed by at least one of the modality signature, a hash of the canonical representation, or the version identifier for a feature transform specification; and
enforcing a compute budget for ingestion by selecting, via a complexity governor, between at least a fast ingestion mode and a full ingestion mode, wherein the fast ingestion mode excludes execution of a learned classifier or descriptor prototype updates and the full ingestion mode includes the learned classifier or descriptor prototype updates.

6. The method of claim 1, wherein the typed structured execution plan is represented in a typed schema and compiled into an executable directed acyclic graph comprising typed operations and parameter constraints.

7. The method of claim 1, further comprising: verifying, prior to deployment of the at least one machine-executable policy constraint, that a set of versioned policy constraints is logically consistent by applying a satisfiability check to the set of versioned policy constraints; and storing a verification result identifier and any identified minimal conflict set in the audit log.

8. The method of claim 1, wherein the privacy parameter comprises a differential privacy epsilon value validated by the policy-checking module prior to executing the at least one predictive or generative model.

9. The method of claim 1, wherein the explanation output comprises a unified time-slice attribution output aggregated from a plurality of edge nodes at sub-second intervals and stored with the audit log.

10. A system for deterministic and explainable multimodal artificial intelligence (AI) orchestration comprising:
a processor; and
a memory component that stores computer-executable instructions that, when executed by the processor, causes the system to perform at least the following:
receive a plurality of input items comprising at least two different modalities including at least one of the following: text, image, audio, video, or sensor-stream data;
canonicalize each input item to form a canonical representation;
compute, from the canonical representation, a modality signature using a predetermined set of deterministic feature transforms;
apply a deterministic hierarchical tagging function to the modality signature to assign a modality identifier, a sub-modality identifier, at least one descriptor identifier, and a sensitivity level selected from a plurality of ordered sensitivity levels;
generate an ingestion-time explainability record comprising at least one of a rule identifier, a rule trace, a feature evidence value, an ambiguity score, a deterministic tie-break outcome, or a version identifier associated with the deterministic hierarchical tagging function;
store the modality identifier, the sub-modality identifier, the at least one descriptor identifier, the sensitivity level, and the ingestion-time explainability record in an ingestion metadata object;
provide the ingestion metadata object to an orchestrator controller configured to generate and compile a typed structured execution plan specifying at least a model selection, a deployment location, and a privacy parameter;
validate the typed structured execution plan with a policy-checking module by evaluating at least one machine-executable policy constraint;
deterministically repair, by the policy-checking module, at least one noncompliant plan parameter to satisfy a violated policy constraint and recording the repair in an audit log; and
execute, in accordance with the typed structured execution plan, at least one predictive or generative model to produce an inference output and an explanation output.

11. The system of claim 10, wherein the policy-checking module comprises a neural policy abstraction layer configured to retrieve relevant policy clauses using semantic representations and to compile at least one policy clause into machine-executable constraints applied to parameters of the typed structured execution plan.

12. The system of claim 10, wherein validating the typed structured execution plan comprises deterministically repairing a noncompliant parameter by overriding the noncompliant parameter to a compliant value and logging the override with a constraint identifier and a reason code.

13. The system of claim 10, further comprising an explainability aggregator configured to merge local feature-attribution outputs computed at edge nodes into a unified time-slice attribution output spanning the at least two different modalities.

14. The system of claim 10, further comprising a federated and edge-cloud manager configured to distribute at least one of training or inference tasks to edge devices, to form an ephemeral edge cluster based on a deterministic threshold for at least one of the following: observed load, latency, or modality composition, and to deterministically select a leader node for the ephemeral edge cluster based on at least one of the following: compute capacity or remaining privacy budget, with deterministic tie-breaking when two or more candidate nodes have equivalent capacity and budget.

15. The system of claim 14, further comprising a differential privacy controller configured to select the privacy parameter as a deterministic function of the sensitivity level and the remaining privacy budget.

16. The system of claim 10, wherein the ingestion-time explainability record includes version identifiers for at least one of a rule set, a learned classifier, a threshold, a descriptor dictionary, or a feature transform specification.

17. The system of claim 10, wherein applying the deterministic hierarchical tagging function comprises executing a rule engine and conditionally executing a learned classifier only when the ambiguity score exceeds a threshold or when a compute budget allows execution of the learned classifier.

18. The system of claim 10, wherein generating the typed structured execution plan comprises selecting between an edge deployment and a cloud deployment based at least in part on the sensitivity level, a latency target, and a policy constraint.

19. A non-transitory computer-readable storage medium that stores instructions that, when executed by a processor, causes a computing device to perform at least the following:
receive a plurality of input items formatted according to at least two different modalities;
canonicalize the plurality of input items to form a canonical representation;
compute, from the canonical representation, a modality signature using a predetermined set of deterministic feature transforms;
apply a deterministic hierarchical tagging function to the modality signature to assign at least one characteristic comprising at least one of the following: a modality identifier, a sub-modality identifier, at least one descriptor identifier, or a sensitivity level selected from a plurality of ordered sensitivity levels;
generate an ingestion-time explainability record comprising at least one of a rule identifier, a rule trace, a feature evidence value, an ambiguity score, a deterministic tie-break outcome, or a version identifier associated with the deterministic hierarchical tagging function;
store the at least one characteristic and the ingestion-time explainability record in an ingestion metadata object;
provide the ingestion metadata object to an orchestrator controller configured to generate and compile a typed structured execution plan specifying at least a model selection, a deployment location, and a privacy parameter, wherein the orchestrator controller selects at least one plan parameter based on the at least one characteristic stored in the ingestion metadata object;
evaluate, by a policy-checking module, at least one machine-executable policy constraint against the typed structured execution plan;
deterministically repair, by the policy-checking module, at least one noncompliant plan parameter of the typed structured execution plan to satisfy a violated policy constraint prior to execution, and recording the repair in an audit log comprising at least a violation identifier and a repair reason code; and
execute, in accordance with the typed structured execution plan, at least one predictive or generative model to produce an inference output and an explanation output associated with the ingestion-time explainability record.

20. The non-transitory computer-readable storage medium of claim 19, wherein the instructions further cause the computing device to assign an emergent descriptor identifier using a deterministic online clustering procedure, to version a descriptor dictionary used by the deterministic online clustering procedure, and to store the emergent descriptor identifier in the ingestion metadata object.
